(19) United States
(12) Patent Application Publication
(10) Pub. No.: US 2026/0270880 A1
(43) Pub. Date: Sep. 10, 2026

(54) PARAMETER CONFIGURATION METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Yuhang JIA, Shenzhen (CN)

(73) Assignee: TENCENT TECHNOLOGY (SHENZHEN) COMPANY LIMITED, Shenzhen (CN)

(21) Appl. No.: 19/665,545

(22) Filed: May 1, 2026

Related U.S. Application Data
(63) Continuation of application No. PCT/CN2024/131398, filed on Nov. 11, 2024.

(30) Foreign Application Priority Data
Dec. 15, 2023 (CN) 202311734474.4

(51) Int. Cl. H04W 52/02

(52) U.S. Cl. CPC H04W 52/0235; H04W 52/0206; H04W 52/0245

(57) ABSTRACT

A method, apparatus, and computer-readable storage medium for parameter configuration method applied to a network data analytics function device is provided. The method obtains energy-saving feature data of a terminal device and energy-saving feature data of a radio access network device corresponding to the terminal device. Energy-saving configuration information corresponding to the terminal device and energy-saving configuration information corresponding to a target network element device associated with the terminal device are generated. The energy-saving configuration information of the terminal device to the terminal device is transmitted. The energy-saving configuration information of the target network element device to the target network element device is transmitted. The terminal device to configure an energy-saving parameter of the terminal device based on the energy-saving configuration information of the terminal device is enabled. The target network element device to configure an energy-saving parameter of the target network element device is enabled.

### CROSS REFERENCE TO RELATED APPLICATION

This application is a bypass continuation application of International Patent Application No. PCT/CN2024/131398, filed on Nov. 11, 2024, which claims priority to and is based on Chinese Patent Application No. 202311734474.4, filed on Dec. 15, 2023, the disclosures of which are incorporated herein in their entireties by reference.

### FIELD

This present disclosure relates to the field of communication technologies, and specifically, to a parameter configuration method and apparatus, an electronic device, and a storage medium.

### BACKGROUND

Communication is applied to an increasing variety of scenes of life to facilitate life. However, with an increase in functions of a communication device and improvement of communication quality, power consumption of the communication device is increasingly high. Therefore, a method is urgently needed for reducing power consumption of the communication device.

### SUMMARY

Provided are a parameter configuration method and apparatus, an electronic device, a storage medium, and a program product, which can reduce power consumption of a terminal device and a network element device associated with the terminal device.

According to an aspect of some embodiments of the present disclosure, a parameter configuration method applied to a network data analytics function device includes obtaining energy-saving feature data of a terminal device and energy-saving feature data of a radio access network device corresponding to the terminal device; generating, based on the energy-saving feature data of the terminal device and the energy-saving feature data of the radio access network device, energy-saving configuration information corresponding to the terminal device and energy-saving configuration information corresponding to a target network element device associated with the terminal device, the energy-saving configuration information being configured to configure an energy-saving parameter; transmitting the energy-saving configuration information of the terminal device to the terminal device; transmitting the energy-saving configuration information of the target network element device to the target network element device; enabling the terminal device to configure an energy-saving parameter of the terminal device based on the energy-saving configuration information of the terminal device; and enabling the target network element device to configure an energy-saving parameter of the target network element device based on the energy-saving configuration information of the target network element device.

According to an aspect of some embodiments of the present disclosure, a parameter configuration apparatus applied to a network data analytics function device includes at least one memory configured to store program code; and at least one processor configured to read the program code and operate as instructed by the program code, the program code including a first obtaining code configured to cause the at least one of the at least one processor to obtain energy-saving feature data of a terminal device and energy-saving feature data of a radio access network device corresponding to the terminal device; a generation code configured to cause the at least one of the at least one processor to generate, based on the energy-saving feature data of the terminal device and the energy-saving feature data of the radio access network device, energy-saving configuration information corresponding to the terminal device and energy-saving configuration information corresponding to a target network element device associated with the terminal device, the energy-saving configuration information being configured to configure an energy-saving parameter; a first transmitting code configured to cause the at least one of the at least one processor to transmit the energy-saving configuration information of the terminal device to the terminal device; a second transmitting code configured to cause the at least one of the at least one processor to transmit the energy-saving configuration information of the target network element device to the target network element device; a first enabling code configured to cause the at least one of the at least one processor to enable the terminal device to configure an energy-saving parameter of the terminal device based on the energy-saving configuration information of the terminal device; and a second enabling code configured to cause the at least one of the at least one processor to enable the target network element device to configure an energy-saving parameter of the target network element device based on the energy-saving configuration information of the target network element device.

According to an aspect of some embodiments of the present disclosure, a non-transitory computer-readable storage medium, storing computer code which, when executed by at least one processor, causes the at least one processor to at least obtain energy-saving feature data of a terminal device and energy-saving feature data of a radio access network device corresponding to the terminal device; generate, based on the energy-saving feature data of the terminal device and the energy-saving feature data of the radio access network device, energy-saving configuration information corresponding to the terminal device and energy-saving configuration information corresponding to a target network element device associated with the terminal device, the energy-saving configuration information being configured to configure an energy-saving parameter; transmit the energy-saving configuration information of the terminal device to the terminal device; transmit the energy-saving configuration information of the target network element device to the target network element device; enable the terminal device to configure an energy-saving parameter of the terminal device based on the energy-saving configuration information of the terminal device; and enable the target network element device to configure an energy-saving parameter of the target network element device based on the energy-saving configuration information of the target network element device.

According to an aspect of some embodiments of the present disclosure, a parameter configuration method, applied to a terminal device includes generating energy-saving feature data of the terminal device; transmitting the energy-saving feature data of the terminal device to a network data analytics function device, to enable the network data analytics function device to generate, based on the energy-saving feature data of the terminal device and energy-saving feature data of a radio access network device corresponding to the terminal device, energy-saving configuration information corresponding to the terminal device and energy-saving configuration information corresponding to a target network element device associated with the terminal device, the energy-saving configuration information being configured for configuring an energy-saving parameter; and receiving the energy-saving configuration information of the terminal device that is transmitted by the network data analytics function device, and configuring an energy-saving parameter of the terminal device based on the received energy-saving configuration information. The method includes encrypting energy-saving data of the terminal device to obtain energy-saving data of the terminal device that is in a ciphertext state, the energy-saving data of the terminal device comprising at least one of network-layer data, power consumption data, and application-layer data of the terminal device, and the network-layer data of the terminal device comprising at least one of reference signal received power, reference signal received quality, a received signal strength indicator, a throughput, and a data rate; and using the energy-saving data of the terminal device that is in the ciphertext state as the energy-saving feature data of the terminal device, to enable the network data analytics function device to generate, based on the energy-saving feature data of the radio access network device and the energy-saving data of the terminal device that is in the ciphertext state, the energy-saving configuration information corresponding to the terminal device and the energy-saving configuration information corresponding to the target network element device. The method includes inputting energy-saving data of the terminal device to a data processing model corresponding to the terminal device, to obtain a data processing result output by the data processing model; and using the data processing result as the energy-saving feature data of the terminal device, to enable the network data analytics function device to input the data processing result and the energy-saving feature data of the radio access network device to an energy-saving configuration generation model, to obtain the energy-saving configuration information corresponding to the terminal device and the energy-saving configuration information corresponding to the target network element device that are output by the energy-saving configuration generation model. The method includes obtaining sample energy-saving data of the terminal device, and training the data processing model based on the sample energy-saving data, to obtain a trained data processing model and a model update parameter; and transmitting the trained data processing model and the model update parameter to an application service device, to enable the application service device to store the trained data processing model and transmit the model update parameter to the network data analytics function device, the model update parameter being configured for updating the energy-saving configuration generation model.

According to an aspect of some embodiments of the present disclosure, a parameter configuration method applied to a radio access network device includes generating energy-saving feature data of the radio access network device; and transmitting the energy-saving feature data of the radio access network device to a network data analytics function device, to enable the network data analytics function device to generate, based on the energy-saving feature data of the radio access network device and energy-saving feature data of a terminal device corresponding to the radio access network device, energy-saving configuration information corresponding to the terminal device and energy-saving configuration information corresponding to a target network element device associated with the terminal device, the energy-saving configuration information being configured for configuring an energy-saving parameter. The method includes receiving a trigger request transmitted by the terminal device, the trigger request being generated by the terminal device after the terminal device transmits the energy-saving feature data of the terminal device to the network data analytics function device; obtaining a network parameter and power consumption data of the radio access network device according to the trigger request, to obtain energy-saving data of the radio access network device, the network parameter of the radio access network device comprising at least one of base station information, cell information, frequency band information, connection information, and network topology information; and generating the energy-saving feature data of the radio access network device based on the energy-saving data of the radio access network device. The method includes obtaining a data transmission record of the terminal device according to the trigger request, and obtaining network configuration information of the terminal device based on the data transmission record of the terminal device; and adding the network configuration information of the terminal device to the energy-saving data of the radio access network device.

According to an aspect of some embodiments of the present disclosure, a parameter configuration apparatus applied to a terminal device includes an obtaining module, configured to generate energy-saving feature data of the terminal device; a transmitting module, configured to transmit the energy-saving feature data of the terminal device to a network data analytics function device, to enable the network data analytics function device to generate, based on the energy-saving feature data of the terminal device and energy-saving feature data of a radio access network device corresponding to the terminal device, energy-saving configuration information corresponding to the terminal device and energy-saving configuration information corresponding to a target network element device associated with the terminal device, the energy-saving configuration information being configured for configuring an energy-saving parameter; and a receiving module, configured to receive the energy-saving configuration information of the terminal device that is transmitted by the network data analytics function device, and configure an energy-saving parameter of the terminal device based on the received energy-saving configuration information.

According to an aspect of some embodiments of the present disclosure, a parameter configuration apparatus, applied to a radio access network device includes a generation module, configured to generate energy-saving feature data of the radio access network device; and a transmitting module, configured to transmit the energy-saving feature data of the radio access network device to a network data analytics function device, to enable the network data analytics function device to generate, based on the energy-saving feature data of the radio access network device and energy-saving feature data of a terminal device corresponding to the radio access network device, energy-saving configuration information corresponding to the terminal device and energy-saving configuration information corresponding to a target network element device associated with the terminal device, the energy-saving configuration information being configured for configuring an energy-saving parameter.

The foregoing general descriptions and the following detailed descriptions are merely for illustration and explanation purposes and are not intended to limit the present disclosure.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment according to an exemplary embodiment of the present disclosure.

FIG. 2 is a flowchart of a parameter configuration method according to an exemplary embodiment of the present disclosure.

FIG. 3 is a flowchart of a parameter configuration method according to another exemplary embodiment of the present disclosure.

FIG. 4 is a flowchart of a parameter configuration method according to another exemplary embodiment of the present disclosure.

FIG. 5 is a flowchart of a parameter configuration method according to another exemplary embodiment of the present disclosure.

FIG. 6 is a flowchart of a parameter configuration method according to another exemplary embodiment of the present disclosure.

FIG. 7 is a flowchart of a parameter configuration method according to another exemplary embodiment of the present disclosure.

FIG. 8 is a flowchart of a parameter configuration method according to another exemplary embodiment of the present disclosure.

FIG. 9 is a flowchart of a parameter configuration method according to another exemplary embodiment of the present disclosure.

FIG. 10 is a flowchart of a parameter configuration method according to another exemplary embodiment of the present disclosure.

FIG. 11 is a flowchart of a parameter configuration method according to another exemplary embodiment of the present disclosure.

FIG. 12 is a flowchart of a parameter configuration method according to another exemplary embodiment of the present disclosure.

FIG. 13 is a flowchart of a parameter configuration method according to another exemplary embodiment of the present disclosure.

FIG. 14 is a flowchart of a parameter configuration method according to another exemplary embodiment of the present disclosure.

FIG. 15 is a schematic diagram of a parameter configuration apparatus according to an exemplary embodiment of the present disclosure.

FIG. 16 is a schematic diagram of a parameter configuration apparatus according to another exemplary embodiment of the present disclosure.

FIG. 17 is a schematic diagram of a parameter configuration apparatus according to another exemplary embodiment of the present disclosure.

FIG. 18 is a schematic structural diagram of a computer system adapted to implement an electronic device according to an embodiment of the present disclosure.

### DETAILED DESCRIPTION

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with the present disclosure. On the contrary, the implementations are merely examples of apparatuses and methods that are described in detail in the appended claims and that are consistent with some aspects of the present disclosure.

In the embodiments of the present disclosure, the term “module” or “unit” is a computer program having a predetermined function or a part of a computer program, operates together with other related parts to achieve a predetermined objective, and may be all or partially implemented by software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or unit.

The block diagrams shown in the accompanying drawings are merely functional entities and do not necessarily correspond to physically independent entities. To be specific, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions. The flow charts (i) do not need to include all content and operations, and (ii) do not need to be performed in the described orders, either. For example, some operations may be further divided while some operations may be combined or partially combined. Therefore, an actual execution order may change based on an actual case. “A plurality of” mentioned in the present disclosure means two or more. “And/or” describes an association relationship between associated objects and indicates that three relationships may exist. For example, A and/or B may indicate the following three cases: Only A exists, both A and B exist, and only B exists. The character “/” usually indicates an “or” relationship between the associated objects.

The technical solutions in the embodiments of the present disclosure are described in detail below.

To reduce power consumption of a device, embodiments of the present disclosure provide a parameter configuration method and apparatus, an electronic device, a storage medium, and a program product in order to reduce power consumption of a terminal device and a network element device associated with the terminal device.

FIG. 1 is a schematic diagram of an implementation environment according to the present disclosure. The implementation environment includes a terminal device, for example, an user equipment (UE) 110, a radio access network (RAN) device 120, a network data analytics function (NWDAF) device 130, and a target network element device 140.

The terminal device 110 may be any type of user equipment, for example, including but not limited to, a smartphone, a tablet computer, a notebook computer, a computer, an intelligent voice interaction device, an intelligent home appliance, an in-vehicle terminal, an aircraft, and a remote driving terminal. The terminal device may alternatively be a virtual device deployed on a server. The server may be an independent physical server, or may be a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. Specific forms of the terminal device and the server are not limited herein.

The radio access network device 120 is a device deployed in a radio access network, and includes, but is not limited to, a base station and the like.

The network data analytics function device 130 is a device that provides a specific network data analytics service for a network.

The target network element device 140 is a network element device associated with the terminal device 110, and includes, but is not limited to, a radio access network device, an application function (AF) device, and the like corresponding to the terminal device 110. The application function device may implement a control plane function of a third-party application server, for example, perform interaction in a manner of “the application function device-a network exposure function (NEF) device” or “the application function device-a policy control function (PCF) device”; or may implement a user plane function of a third-party application server, for example, perform interaction in a manner of “the application function device-an Internet Protocol (IP) transport network-a user plane function (UPF) interface”. The network exposure function device is located between a core network and an external third-party application function device, and is configured to manage exposed network data. An external application needs to access internal data of the core network through the network exposure function device. The network exposure function device provides corresponding security guarantee to ensure security of the external application to the network, and provides functions such as quality of service (QoS) customization ability exposure for external applications, mobility state event subscription, and AF request distribution. The policy control function device is configured to provide policy rules for control plane functions. A user plane function device is configured for packet routing and forwarding, policy implementation, traffic reporting, QoS handling, and the like.

In an exemplary embodiment, the parameter configuration method provided in the embodiments of the present disclosure may be jointly performed by the terminal device 110, the radio access network device 120, the network data analytics function device 130, and the target network element device 140. For example, the terminal device 110 may obtain energy-saving data of the terminal device 110, generate energy-saving feature data based on the energy-saving data, and transmit the energy-saving feature data to the network data analytics function device 130. The radio access network device 120 corresponding to the terminal device 110 may also obtain energy-saving data of the radio access network device 120, generate energy-saving feature data based on the energy-saving data, and transmit the energy-saving feature data to the network data analytics function device 130. The network data analytics function device 130 generates, based on the energy-saving feature data of the terminal device 110 and the energy-saving feature data of the radio access network device 120, energy-saving configuration information corresponding to the terminal device 110 and energy-saving configuration information corresponding to the target network element device 140 associated with the terminal device 110, transmits the energy-saving configuration information of the terminal device 110 to the terminal device 110, and transmits the energy-saving configuration information of the target network element device 140 to the target network element device 140 in order to enable the terminal device 110 to configure an energy-saving parameter based on the received energy-saving configuration information, and enable the target network element device 140 to configure an energy-saving parameter based on the received energy-saving configuration information. During generation of the energy-saving configuration information of the terminal device, both the energy-saving feature data of the terminal device and the energy-saving feature data of the radio access network device corresponding to the terminal device are considered in order to improve accuracy of the energy-saving configuration information of the terminal device, and reduce power consumption of the terminal device. In addition, both the energy-saving configuration information of the terminal device and energy-saving configuration information of a network element device associated with the terminal device are generated, so that energy-saving control on the terminal device is associated with energy-saving control on the network element device associated with the terminal device. This can not only further reduce power consumption of the terminal device, but also reduce power consumption of an entire network. Moreover, the energy-saving configuration information is generated by the network data analytics function device with a powerful data analytics function, so that accuracy and generation efficiency of the energy-saving configuration information can be improved.

Quantities of the terminal device 110, the radio access network device 120, the network data analytics function device 130, and the target network element device 140 in FIG. 1 are merely examples. According to an actual requirement, there may be any quantities of terminal devices 110, radio access network devices 120, network data analytics function devices 130, and target network element devices 140.

User-related data such as energy-saving data is involved in the embodiments of the present disclosure. When the method in the present disclosure is applied to a specific product or technology, user permission or consent is obtained, and extraction, use, and processing of related data comply with provisions of local security standards and local laws and regulations. The method provided in the embodiments of the present disclosure may be applied to a parameter configuration scenario in a network, for example, a 5G network.

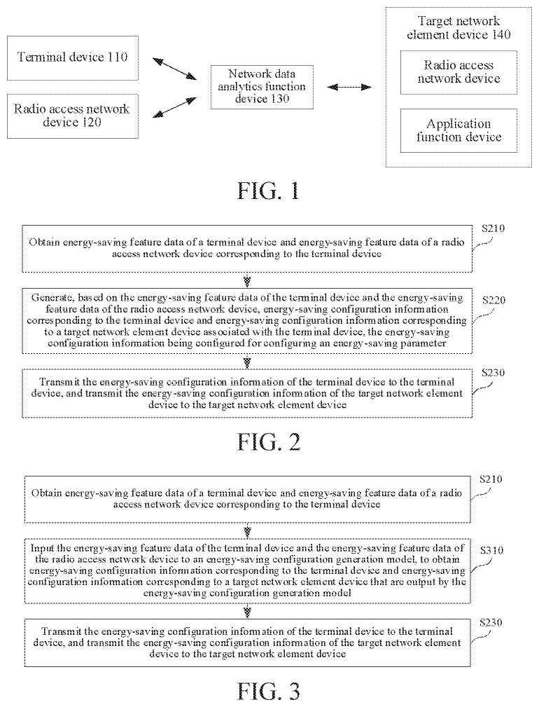

FIG. 2 is a flowchart of a parameter configuration method according to an exemplary embodiment of the present disclosure. The method may be applied to the implementation environment shown in FIG. 1, and may be performed by the network data analytics function device 130 in the implementation environment shown in FIG. 1.

As shown in FIG. 2, in an exemplary embodiment, the parameter configuration method may include S210 to S230. Detailed descriptions are as follows:

S210: The network data analytics function device obtains energy-saving feature data of a terminal device and energy-saving feature data of a radio access network device corresponding to the terminal device.

To reduce power consumption for energy saving and emission reduction, the energy-saving feature data of the terminal device and the energy-saving feature data of the radio access network device corresponding to the terminal device may be obtained.

The radio access network device corresponding to the terminal device is a device providing a data transmission service for the terminal device, that is, a device in a radio access network to which the terminal device is connected. A device type includes, but is not limited to, a base station and the like.

The energy-saving feature data is data that can represent an energy-saving feature, and may be generated based on energy-saving data. The energy-saving data is any data related to power consumption. For the terminal device, service data transmission and the like affect power consumption of the terminal device. Energy-saving data of the terminal device includes, but is not limited to, at least one of network-layer data, power consumption data, and application-layer data of the terminal device. The network-layer data of the terminal device includes, but is not limited to, a QoS parameter of the terminal device, for example, at least one of reference signal received power (RSRP), reference signal received quality (RSRQ), a received signal strength indicator (RSSI), a throughput, and a data rate of the terminal device. The power consumption data of the terminal device includes, but is not limited to, total power consumption, average power consumption, power consumption in an uplink transmission channel, power consumption in a downlink transmission channel, power consumption of different services, and the like of the terminal device within a specified time period. The application-layer data of the terminal device includes service data of the terminal device, for example, a service type of a service that is currently run and service requirement information. The service of the terminal device includes, but is not limited to, an email, an SMS message, a video call, a voice call, and the like. The service requirement information is configured to describe a service requirement. For example, an instant messaging service like the video call or the voice call has a high requirement on a data transmission delay, and a non-instant-messaging service like the email has a low requirement on a data transmission delay. For the radio access network device, energy-saving data of the radio access network device includes, but is not limited to, a network parameter of the radio access network device, for example, at least one of base station information (for example, a location, a type, a name, and the like of a base station), cell information (for example, a number, a location, a coverage area, a coverage type, and the like of a cell), frequency band information (for example, a used frequency band, a frequency range, bandwidth, and the like), user connection information (for example, a quantity of users connected to the base station or the cell, a user type, and the like), and network topology information (for example, a relationship between base stations and cells in a network, including neighboring cell information, handover information, and the like).

For a specific manner of generating, by the network data analytics function device, the energy-saving feature data of the terminal device based on the energy-saving data of the terminal device and a specific manner of generating the energy-saving feature data of the radio access network device based on the energy-saving data of the radio access network device, refer to subsequent descriptions. Details are not described herein.

In some embodiments, the energy-saving feature data of the terminal device may be generated by the terminal device based on the energy-saving data of the terminal device. Under this condition, that the network data analytics function device obtains the energy-saving feature data of the terminal device includes receiving the energy-saving feature data transmitted by the terminal device. Alternatively, the energy-saving feature data of the terminal device may be generated, based on the energy-saving data of the terminal device, by an over-the-top server (OTT server) device corresponding to the terminal device. Under this condition, that the network data analytics function device obtains the energy-saving feature data of the terminal device includes receiving the energy-saving feature data of the terminal device that is transmitted by an application service device.

S220: The network data analytics function device generates, based on the energy-saving feature data of the terminal device and the energy-saving feature data of the radio access network device, energy-saving configuration information corresponding to the terminal device and energy-saving configuration information corresponding to a target network element device associated with the terminal device, the energy-saving configuration information being configured to configure an energy-saving parameter.

The energy-saving configuration information is configured to configure an energy-saving parameter. The energy-saving parameter is any parameter related to power consumption, for example, a network resource (for example, bandwidth, a frequency band, a quantity of channels, and the like), an amount of transmitted data, traffic, and a QoS parameter. Different energy-saving parameters correspond to different power consumption, and different network element devices correspond to different types of energy-saving parameters. For example, for the terminal device and the radio access network device, an energy-saving parameter corresponding to the radio access network device includes a quantity of cells, and an energy-saving parameter corresponding to the terminal device includes bandwidth configured by the radio access network device for the terminal device.

The target network element device is a network element device associated with the terminal device, for example, at least one of a network element device providing a service for the terminal device and a device in a communication connection to the terminal device. A type of the target network element device includes, but is not limited to, at least one of a radio access network device, an application function device, and the like.

After the energy-saving feature data corresponding to the terminal device and the energy-saving feature data corresponding to the radio access network device are obtained, the obtained energy-saving feature data may be analyzed and processed, and the energy-saving configuration information of the terminal device and the energy-saving configuration information of the target network element device are generated based on an analysis and processing result.

A specific manner of generating the energy-saving configuration information by the network data analytics function device may be flexibly set according to an actual requirement.

In an implementation, in a process of generating the energy-saving configuration information, the network data analytics function device may generate the energy-saving configuration information corresponding to the terminal device and the energy-saving configuration information corresponding to the target network element device, with an objective to reduce power consumption of the terminal device and the target network element device and improve QoS of the terminal device while ensuring a service transmission requirement of the terminal device. In another example, a power consumption trend of the terminal device may be predicted based on the energy-saving feature data of the terminal device and the energy-saving feature data of the radio access network device, and the energy-saving configuration information is generated based on the power consumption trend. If the power consumption trend of the terminal device is that power consumption increases and exceeds a specified power consumption threshold, the energy-saving configuration information corresponding to the terminal device and the energy-saving configuration information corresponding to the target network element device are generated with an objective to reduce power consumption of the terminal device. For example, energy-saving configuration information for reducing bandwidth of the terminal device or reducing an amount of data transmitted by the target network element device to the terminal device is generated. If the power consumption trend of the terminal device is that power consumption decreases and is lower than a specified power consumption threshold, the energy-saving configuration information corresponding to the terminal device and the energy-saving configuration information corresponding to the target network element device are generated with an objective to ensure that power consumption of the terminal device is lower than the specified power consumption threshold and improve QoS of the terminal device. For example, energy-saving configuration information for increasing an amount of data transmitted by the terminal device or increasing an amount of data transmitted by the target network element device to the terminal device may be generated.

In an implementation, the network data analytics function device inputs the energy-saving feature data of the terminal device and the energy-saving feature data of the radio access network device to an energy-saving configuration generation model in order to obtain the energy-saving configuration information corresponding to the terminal device and the energy-saving configuration information corresponding to the target network element device that are output by the energy-saving configuration generation model.

S230: The network data analytics function device transmits the energy-saving configuration information of the terminal device to the terminal device, and transmits the energy-saving configuration information of the target network element device to the target network element device.

After generating the energy-saving configuration information corresponding to the terminal device and the energy-saving configuration information corresponding to the target network element device, the network data analytics function device may transmit the energy-saving configuration information of the terminal device to the terminal device, and transmit the energy-saving configuration information of the target network element device to the target network element device in order to enable the terminal device to configure the energy-saving parameter of the terminal device based on the received energy-saving configuration information of the terminal device, and enable the target network element device to configure the energy-saving parameter of the target network element device based on the received energy-saving configuration information of the target network element device. For example, if the target network element device is a radio access network device connected to the terminal device and the energy-saving configuration information corresponding to the target network element device is to reduce bandwidth of the terminal device, the radio access network device may reduce bandwidth allocated by the radio access network device to the terminal device.

In this embodiment of the present disclosure, that the network data analytics function device transmits the generated energy-saving configuration information of the terminal device to the terminal device may include at least the following several trigger conditions:
(i) In a trigger condition, after generating the energy-saving configuration information of the terminal device, the network data analytics function device may transmit the energy-saving configuration information of the terminal device to the terminal device.
(ii) In another trigger condition, after receiving an energy-saving configuration obtaining request from the terminal device, the network data analytics function device transmits the energy-saving configuration information of the terminal device to the terminal device.

In the embodiment shown in FIG. 2, in a process of generating the energy-saving configuration information of the terminal device, the network data analytics function device considers both the energy-saving feature data of the terminal device and the energy-saving feature data of the radio access network device corresponding to the terminal device in order to improve accuracy of the energy-saving configuration information of the terminal device, and reduce power consumption of the terminal device. In addition, because the target network element device associated with the terminal device affects power consumption of the terminal device, both the energy-saving configuration information of the terminal device and the energy-saving configuration information of the target network element device associated with the terminal device are generated, so that energy-saving control on the terminal device is associated with energy-saving control on the target network element device associated with the terminal device. This can not only further reduce power consumption of the terminal device, but also reduce power consumption of an entire network. Moreover, the energy-saving configuration information is generated by the network data analytics function device with a powerful data analytics function, so that accuracy and generation efficiency of the energy-saving configuration information can be improved. Furthermore, the network data analytics function device needs to obtain only the energy-saving feature data corresponding to the terminal device and the energy-saving feature data corresponding to the radio access network device, so that an amount of transmitted data can be reduced.

In an exemplary embodiment, FIG. 3 is a flowchart of a parameter configuration method according to another exemplary embodiment of the present disclosure. The method may be applied to the implementation environment shown in FIG. 1, and may be performed by the network data analytics function device 130 in the implementation environment shown in FIG. 1.

As shown in FIG. 3, the parameter configuration method includes S210, S310, and S230. Detailed descriptions of S310 are as follows:

S310: The network data analytics function device inputs the energy-saving feature data of the terminal device and the energy-saving feature data of the radio access network device to an energy-saving configuration generation model in order to obtain energy-saving configuration information corresponding to the terminal device and energy-saving configuration information corresponding to a target network element device that are output by the energy-saving configuration generation model.

To improve accuracy of the energy-saving configuration information, the energy-saving configuration generation model may be deployed. The energy-saving configuration generation model is a machine learning (ML) model and is configured to generate, based on the energy-saving feature data of the terminal device and the energy-saving feature data of the radio access network device, the energy-saving configuration information corresponding to the terminal device and the energy-saving configuration information corresponding to the target network element device.

Machine learning is multidisciplinary relating to a plurality of fields such as the probability theory, statistics, the approximation theory, convex analysis, and the algorithm complexity theory. Machine learning specializes in studying how a computer simulates or implements human learning behavior to obtain new knowledge or skills, and reorganize an existing knowledge structure, to keep improving its performance. Machine learning is (i) the core of artificial intelligence, (ii) a basic way to make the computer intelligent, and (iii) applied to various fields of artificial intelligence. Machine learning and deep learning generally include technologies such as an artificial neural network, a belief network, reinforcement learning, transfer learning, inductive learning, and learning from demonstrations.

The machine learning model may be pre-trained by using a training sample in order to obtain the energy-saving configuration generation model. A specific training manner may be flexibly set according to an actual requirement. In an example, the network data analytics function device may obtain sample energy-saving feature data from the terminal device, sample energy-saving feature data from the radio access network device corresponding to the terminal device, and sample energy-saving configuration information corresponding to the sample energy-saving feature data, and perform training based on the sample energy-saving feature data and the corresponding sample energy-saving configuration information to obtain the energy-saving configuration generation model.

A type of the energy-saving configuration generation model includes, but is not limited to, a convolutional neural network, a Gaussian mixture model, a federated learning model, and the like.

For specific implementation details of S210 and S230 shown in FIG. 3, refer to S210 and S230 shown in FIG. 2. Details are not described herein again.

In the embodiment shown in FIG. 3, the energy-saving configuration information is generated by using the machine learning model technology in order to improve accuracy of the energy-saving configuration information.

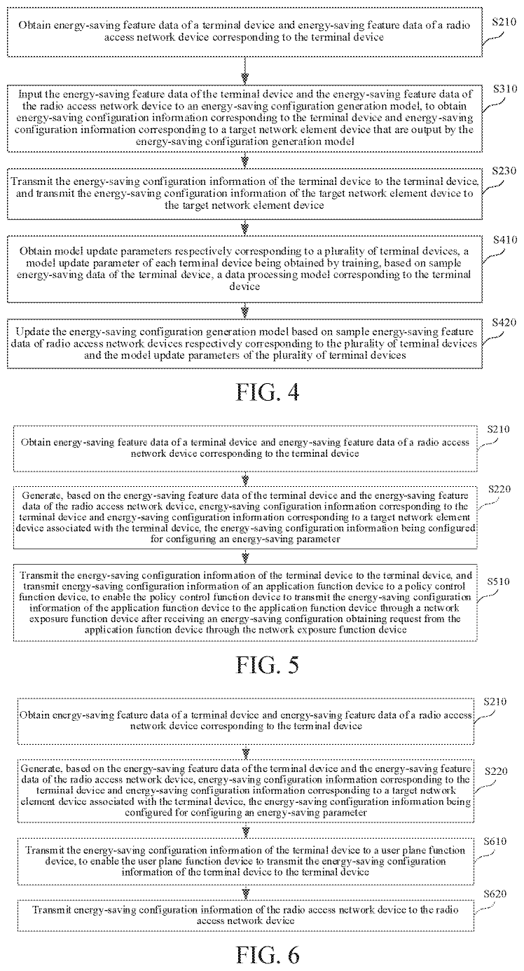

In an exemplary embodiment, FIG. 4 is a flowchart of a parameter configuration method according to another exemplary embodiment of the present disclosure. The method may be applied to the implementation environment shown in FIG. 1, and may be performed by the network data analytics function device 130 in the implementation environment shown in FIG. 1.

As shown in FIG. 4, under the condition that energy-saving feature data of a terminal device includes a data processing result output by a data processing model corresponding to the terminal device after the data processing model processes energy-saving data of the terminal device, the parameter configuration method includes S210, S310, S230, S410, and S420. Detailed descriptions of S410 and S420 are as follows:

S410: The network data analytics function device obtains model update parameters respectively corresponding to a plurality of terminal devices, a model update parameter of each terminal device being obtained by training, based on sample energy-saving data of the terminal device, a data processing model corresponding to the terminal device.

To improve security of energy-saving data of a terminal device and reduce an amount of data transmitted between the terminal device and the network data analytics function device, a data processing model may be deployed on the terminal device side, the energy-saving data of the terminal device is processed by using the data processing model to obtain a data processing result, and the data processing result is used as energy-saving feature data of the terminal device. The data processing model of the terminal device may be stored on the terminal device, or stored on an application service device corresponding to the terminal device. If the data processing model is stored on the terminal device, that the network data analytics function device obtains the energy-saving feature data of the terminal device includes receiving the data processing result transmitted by the terminal device. If the data processing model is stored on the application service device, that the network data analytics function device obtains the energy-saving feature data of the terminal device includes receiving the data processing result transmitted by the application service device.

Under the condition that the data processing model is deployed on the terminal device side, an update of the data processing model may affect accuracy of the energy-saving configuration generation model. Therefore, a data processing model of each terminal device may be trained based on sample energy-saving data of the terminal device to obtain a model update parameter, and the model update parameter is transmitted to the network data analytics function device. The sample energy-saving data of the terminal device is energy-saving data of the terminal device that is used as a training sample.

The network data analytics function device may obtain the model update parameters respectively corresponding to the plurality of terminal devices. The data processing model may be trained by the terminal device, or may be trained by the application service device corresponding to the terminal device. Correspondingly, that the network data analytics function device obtains the model update parameter corresponding to the terminal device includes: The network data analytics function device receives the model update parameter transmitted by the terminal device or transmitted by the application service device corresponding to the terminal device.

S420: The network data analytics function device updates the energy-saving configuration generation model based on sample energy-saving feature data of radio access network devices respectively corresponding to the plurality of terminal devices and the model update parameters of the plurality of terminal devices.

Sample energy-saving feature data of a radio access network device is energy-saving feature data of the radio access network device that is used as a training sample, and may be generated based on sample energy-saving data of the radio access network device.

After obtaining the model update parameters respectively corresponding to the plurality of terminal devices, the network data analytics function device may update a configuration information data processing model based on the sample energy-saving feature data of the radio access network devices respectively corresponding to the plurality of terminal devices and the obtained model update parameters.

In an example, to improve security of energy-saving data of a radio access network device and reduce an amount of data transmitted between the radio access network device and the network data analytics function device, a data processing model may be deployed on the radio access network device, the energy-saving data of the radio access network device is processed by using the data processing model of the radio access network device to obtain a data processing result, and the data processing result is used as energy-saving feature data of the radio access network device. Under this condition, an update of the data processing model of the radio access network device also affects the energy-saving configuration generation model. Therefore, the radio access network device may train the local data processing model based on sample energy-saving data of the radio access network device to obtain a trained data processing model and a model update parameter, and transmit the model update parameter to the network data analytics function device. The network data analytics function device may aggregate the model update parameters of the plurality of terminal devices and model update parameters of a plurality of radio access network devices, and update the energy-saving configuration generation model based on an aggregation result.

In some embodiments, after updating the energy-saving configuration generation model, the network data analytics function device may further generate a model update instruction, and separately transmit the model update instruction to a training device corresponding to a data processing model of a terminal device (that is, the terminal device or an application service device corresponding to the terminal device) and a radio access network device, so that the training device updates the data processing model of the terminal device according to the model update instruction, and the radio access network device updates a data processing model of the radio access network device according to the model update instruction. That is, updates of the data processing model of the radio access network device, the data processing model of the terminal device, and the energy-saving configuration generation model may be associated. In an example, a vertical federated learning model may be formed.

For specific implementation details of S210 and S230 shown in FIG. 4, refer to S210 and S230 shown in FIG. 2. For specific implementation details of S310 shown in FIG. 4, refer to S310 shown in FIG. 3. Details are not described herein again.

In the embodiment shown in FIG. 4, in a process of generating the energy-saving configuration information, the network data analytics function device obtains the data processing result obtained by the data processing model of the terminal device by performing data processing on the energy-saving data of the terminal device. This can not only reduce an amount of transmitted data, but also improve data security of the terminal device. In addition, during a model update, the network data analytics function device may update the energy-saving configuration generation model based on the model update parameters of the plurality of terminal devices and sample energy-saving feature data of the plurality of radio access network devices in order to improve accuracy of the energy-saving configuration generation model.

In an exemplary embodiment, FIG. 5 is a flowchart of a parameter configuration method according to another exemplary embodiment of the present disclosure. The method may be applied to the implementation environment shown in FIG. 1, and may be performed by the network data analytics function device 130 in the implementation environment shown in FIG. 1.

As shown in FIG. 5, under the condition that a target network element device includes an application function device corresponding to a terminal device, the parameter configuration method includes S210, S220, and S510. Detailed descriptions of S510 are as follows:

S510: The network data analytics function device transmits the energy-saving configuration information of the terminal device to the terminal device, and transmits energy-saving configuration information of an application function device to a policy control function device in order to enable the policy control function device to transmit the energy-saving configuration information of the application function device to the application function device through a network exposure function device after receiving an energy-saving configuration obtaining request from the application function device through the network exposure function device.

An application function device corresponding to the terminal device is an application function device providing a service for the terminal device, and also affects power consumption of the terminal device. Therefore, the device may serve as the target network element device.

Under the condition that the target network element device includes the application function device, the network data analytics function device generates the energy-saving configuration information of the application function device and transmits the energy-saving configuration information of the application function device to the application function device. After receiving the energy-saving configuration information, the application function device may configure an energy-saving parameter of the application function device based on the energy-saving configuration information. The energy-saving parameter may include a power consumption parameter of the application function device, or may include a parameter related to power consumption of the terminal device, for example, an amount of data transmitted between the application function device and the terminal device in order to reduce power consumption of the terminal device while reducing power consumption of the application function device.

During transmission, the network data analytics function device may transmit the energy-saving configuration information of the application function device to the policy control function device, then the policy control function device transmits the energy-saving configuration information of the application function device to the network exposure function device, and then the network exposure function device transmits the energy-saving configuration information of the application function device to the application function device. That is, during transmission, the energy-saving configuration information of the application function device is transmitted by the network data analytics function device and reaches the application function device through the policy control function device and the network exposure function device.

The application function device may transmit the energy-saving configuration obtaining request to the network exposure function device, and the network exposure function device transmits the energy-saving configuration obtaining request to the policy control function device. Based on the network exposure function device according to the energy-saving configuration obtaining request, the energy-saving configuration of the application function device is received from the network data analytics function device. Then the network exposure function device transmits the energy-saving configuration information to the application function device. The energy-saving configuration obtaining request is configured to request obtaining the energy-saving configuration information. In some embodiments, after receiving the energy-saving configuration information, the application function device may transmit an acknowledgement message to the network exposure function device, so that the network exposure function device determines that the application function device has received the energy-saving configuration information.

In some embodiments, after generating the energy-saving configuration information of the application function device, the network data analytics function device may actively transmit the energy-saving configuration information to the policy control function device, or the network data analytics function device may transmit the energy-saving configuration information to the policy control function device after receiving a request that is transmitted by the policy control function device for obtaining the energy-saving configuration information of the application function device. After receiving the energy-saving configuration obtaining request from the application function device, the policy control function device may transmit the request to the network data analytics function device for obtaining the energy-saving configuration information of the application function device.

For specific implementation details of S210 and S220 shown in FIG. 5, refer to S210 and S220 shown in FIG. 2. Details are not described herein again.

In the embodiment shown in FIG. 5, a large amount of data is transmitted between the terminal device and the application function device corresponding to the terminal device, affecting power consumption of the terminal device. Therefore, the energy-saving configuration information of the application function device corresponding to the terminal device is further generated to associate power consumption control on the terminal device with power consumption control on the application function device, and reduce power consumption of the terminal device and power consumption of the application function device. In addition, the network data analytics function device transmits the energy-saving configuration information to the application function device through the policy control function device and the network exposure function device to increase a data transmission success rate. Further, the energy-saving configuration information is transmitted to the application function device only as requested by the application function device, so that security of the application function device can be improved.

In an exemplary embodiment, FIG. 6 is a flowchart of a parameter configuration method according to another exemplary embodiment of the present disclosure. The method may be applied to the implementation environment shown in FIG. 1, and may be performed by the network data analytics function device 130 in the implementation environment shown in FIG. 1.

As shown in FIG. 6, under the condition that a target network element device includes a radio access network device, the parameter configuration method includes S210, S220, S610, and S620. Detailed descriptions of S610 and S620 are as follows:

S610: The network data analytics function device transmits the energy-saving configuration information of the terminal device to a user plane function device in order to enable the user plane function device to transmit the energy-saving configuration information of the terminal device to the terminal device.

To transmit the energy-saving configuration information of the terminal device to the terminal device, the network data analytics function device may first transmit the energy-saving configuration information of the terminal device to the user plane function device, and the user plane function device exposes the energy-saving configuration information of the terminal device to the terminal device. In other words, the user plane function device transmits the energy-saving configuration information of the terminal device to the terminal device.

In some embodiments, after receiving the energy-saving configuration information, the terminal device may transmit acknowledgement information to the user plane function device, so that the user plane function device determines, based on the acknowledgement information, that the terminal device has successfully received the energy-saving configuration information.

In some embodiments, the user plane function device may transmit the energy-saving configuration information of the terminal device to the terminal device through an N6 interface.

S620: The network data analytics function device transmits energy-saving configuration information of the radio access network device to the radio access network device.

The radio access network device corresponding to the terminal device also affects power consumption of the terminal device. Therefore, the network data analytics function device may alternatively use the radio access network device corresponding to the terminal device as the target network element device. Correspondingly, the network data analytics function device generates the energy-saving configuration information of the radio access network device and transmits the energy-saving configuration information to the radio access network device.

For specific implementation details of S210 and S220 shown in FIG. 6, refer to S210 and S220 shown in FIG. 2. Details are not described herein again.

In the embodiment shown in FIG. 6, a large amount of data is transmitted between the terminal device and the radio access network device corresponding to the terminal device, which affects power consumption of the terminal device. Therefore, the energy-saving configuration information of the radio access network device is further generated to associate power consumption control on the terminal device with power consumption control on the radio access network device, and reduce power consumption of the terminal device and power consumption of the radio access network device. In addition, the network data analytics function device transmits the energy-saving configuration information to the terminal device through the user plane function device in order to increase a data transmission success rate and improve data transmission efficiency.

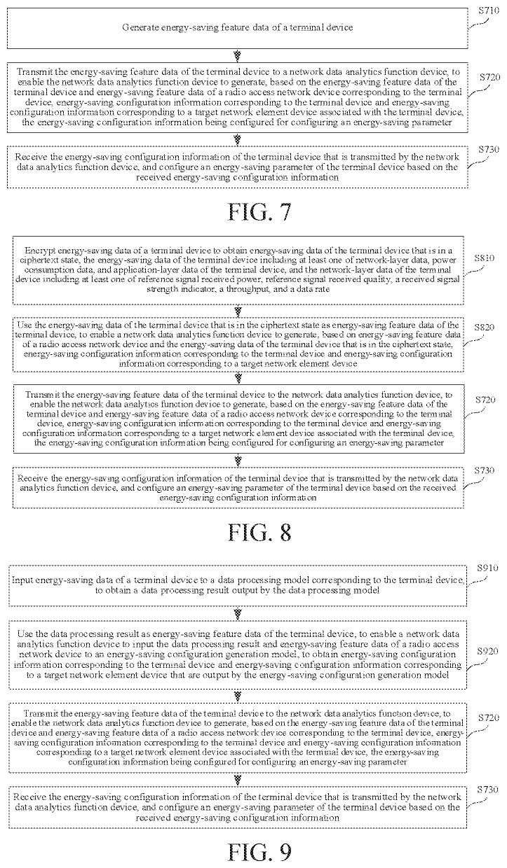

FIG. 7 is a flowchart of a parameter configuration method according to an exemplary embodiment of the present disclosure. The method may be applied to the implementation environment shown in FIG. 1, and may be performed by the terminal device 110 in the implementation environment shown in FIG. 1.

As shown in FIG. 7, in an exemplary embodiment, the parameter configuration method includes S710 to S730. Detailed descriptions of S710 to S730 are as follows:

S710: The terminal device generates energy-saving feature data of the terminal device.

When energy-saving control is needed, the terminal device may generate the energy-saving feature data of the terminal device. In some embodiments, the terminal device may generate the energy-saving feature data of the terminal device based on energy-saving data of the terminal device.

A specific manner of generating the energy-saving feature data by the terminal device may be flexibly set according to an actual requirement.

In an example, the terminal device may directly use the energy-saving data of the terminal device as the energy-saving feature data.

In an example, the terminal device may preprocess the energy-saving data of the terminal device, and use preprocessed energy-saving data as the energy-saving feature data of the terminal device.

In some embodiments, the terminal device may periodically obtain energy-saving data of the terminal device, generate energy-saving feature data, and then transmit the energy-saving feature data to a network data analytics function device in order to generate energy-saving configuration information. That is, the terminal device may periodically request the network data analytics function device to generate energy-saving configuration information.

In some embodiments, alternatively, the terminal device may non-periodically request the network data analytics function device to generate energy-saving configuration information. In an example, when power consumption of the terminal device is greater than a specified threshold, the terminal device may obtain energy-saving data and transmit energy-saving feature data to the network data analytics function device in order to request the network data analytics function device to generate energy-saving configuration information. Alternatively, frequency at which the terminal device requests the network data analytics function device to generate energy-saving configuration information may be positively correlated with power consumption of the terminal device. To be specific, higher power consumption indicates higher request frequency.

S720: The terminal device transmits the energy-saving feature data of the terminal device to the network data analytics function device in order to enable the network data analytics function device to generate, based on the energy-saving feature data of the terminal device and energy-saving feature data of a radio access network device corresponding to the terminal device, energy-saving configuration information corresponding to the terminal device and energy-saving configuration information corresponding to a target network element device associated with the terminal device, the energy-saving configuration information being configured to configure an energy-saving parameter.

After obtaining the energy-saving feature data of the terminal device, the terminal device may transmit the energy-saving feature data of the terminal device to the network data analytics function device in order to enable the network data analytics function device to generate, based on the energy-saving feature data of the terminal device and the energy-saving feature data of the radio access network device corresponding to the terminal device, the energy-saving configuration information corresponding to the terminal device and the energy-saving configuration information corresponding to the target network element device. For descriptions of a process of generating, by the network data analytics function device, the energy-saving configuration information corresponding to the terminal device and the energy-saving configuration information corresponding to the target network element, refer to the descriptions in the foregoing embodiments. Details are not described herein again.

S730: The terminal device receives the energy-saving configuration information of the terminal device that is transmitted by the network data analytics function device, and configures an energy-saving parameter of the terminal device based on the received energy-saving configuration information.

After receiving the energy-saving configuration information of the terminal device that is transmitted by the network data analytics function device, the terminal device may configure the energy-saving parameter of the terminal device based on the energy-saving configuration information.

In the embodiment shown in FIG. 7, in a process of generating the energy-saving configuration information of the terminal device, the network data analytics function device considers both the energy-saving feature data of the terminal device and the energy-saving feature data of the radio access network device corresponding to the terminal device in order to improve accuracy of the energy-saving configuration information of the terminal device, and reduce power consumption of the terminal device. In addition, because a network element device associated with the terminal device also affects power consumption of the terminal device, the network data analytics function device generates both the energy-saving configuration information of the terminal device and energy-saving configuration information of the network element device associated with the terminal device, so that energy-saving control on the terminal device is associated with energy-saving control on the network element device associated with the terminal device. This can not only further reduce power consumption of the terminal device, but also reduce power consumption of an entire network. Moreover, the energy-saving configuration information is generated by the network data analytics function device with a powerful data analytics function, so that accuracy and generation efficiency of the energy-saving configuration information can be improved. Furthermore, the network data analytics function device needs to obtain only the energy-saving feature data corresponding to the terminal device and the energy-saving feature data corresponding to the radio access network device, so that an amount of transmitted data can be reduced.

In an exemplary embodiment, FIG. 8 is a flowchart of a parameter configuration method according to another exemplary embodiment of the present disclosure. The method may be applied to the implementation environment shown in FIG. 1, and may be performed by the terminal device 110 in the implementation environment shown in FIG. 1.

As shown in FIG. 8, the parameter configuration method includes S810, S820, S720, and S730. Detailed descriptions of S810 and S820 are as follows:

S810: The terminal device encrypts energy-saving data of the terminal device to obtain energy-saving data of the terminal device that is in a ciphertext state, the energy-saving data of the terminal device including at least one of network-layer data, power consumption data, and application-layer data of the terminal device, and the network-layer data of the terminal device including at least one of reference signal received power, reference signal received quality, a received signal strength indicator, a throughput, and a data rate.

For descriptions of the energy-saving data, the network-layer data, the power consumption data, and the application-layer data of the terminal device, refer to the foregoing examples. Details are not described herein again.

After obtaining the energy-saving data of the terminal device, the terminal device may encrypt the energy-saving data to obtain the energy-saving data of the terminal device that is in the ciphertext state. An encryption algorithm is an algorithm in which an output obtained by processing encrypted data that is consistent with an output obtained by processing unencrypted data in a same processing manner, for example, a homomorphic encryption algorithm. In this way, a network data analytics function device can generate, based on the energy-saving data of the terminal device that is in the ciphertext state, energy-saving configuration information corresponding to the terminal device and energy-saving configuration information corresponding to a target network element device in order to ensure data security on the terminal device side.

S820: The terminal device uses the energy-saving data of the terminal device that is in the ciphertext state as energy-saving feature data of the terminal device in order to enable the network data analytics function device to generate, based on energy-saving feature data of a radio access network device and the energy-saving data of the terminal device that is in the ciphertext state, the energy-saving configuration information corresponding to the terminal device and the energy-saving configuration information corresponding to the target network element device.

The terminal device may use the energy-saving data of the terminal device that is in the ciphertext state as the energy-saving feature data of the terminal device, and transmit the energy-saving feature data to the network data analytics function device. The network data analytics function device generates, based on the energy-saving feature data of the radio access network device and the energy-saving data of the terminal device that is in the ciphertext state, the energy-saving configuration information of the terminal device and the energy-saving configuration information corresponding to the target network element device. That is, during generation of the energy-saving configuration information, the energy-saving data of the terminal device remains in an encrypted state.

For implementation details of S720 and S730 shown in FIG. 8, refer to S720 and S730 shown in FIG. 7. Details are not described herein again.

In the embodiment shown in FIG. 8, the terminal device transmits the energy-saving data of the terminal device that is in the ciphertext state to the network data analytics function device in order to enable the network data analytics function device to generate the energy-saving configuration information based on the energy-saving data of the terminal device that is in the ciphertext state. This can improve data security of the terminal device.

In an exemplary embodiment, FIG. 9 is a flowchart of a parameter configuration method according to another exemplary embodiment of the present disclosure. The method may be applied to the implementation environment shown in FIG. 1, and may be performed by the terminal device 110 in the implementation environment shown in FIG. 1.

As shown in FIG. 9, the parameter configuration method includes S910, S920, S720, and S730. Detailed descriptions of S910 and S920 are as follows:

S910: The terminal device inputs energy-saving data of the terminal device to a data processing model corresponding to the terminal device in order to obtain a data processing result output by the data processing model.

To improve security of the energy-saving data of the terminal device and reduce an amount of data transmitted between the terminal device and a network data analytics function device, the data processing model may be deployed on the terminal device side, and after the energy-saving data of the terminal device is obtained, the energy-saving data of the terminal device may be processed by using the data processing model in order to obtain the data processing result.

The data processing model of the terminal device is a machine learning model, and may be a model for extracting feature data from the energy-saving data of the terminal device, or may be a model for generating energy-saving configuration information of the terminal device based on the energy-saving data of the terminal device.

S920: The terminal device uses the data processing result as energy-saving feature data of the terminal device in order to enable the network data analytics function device to input the data processing result and energy-saving feature data of a radio access network device to an energy-saving configuration generation model, to obtain energy-saving configuration information corresponding to the terminal device and energy-saving configuration information corresponding to a target network element device that are output by the energy-saving configuration generation model.

In this embodiment of the present disclosure, after obtaining the data processing result corresponding to the energy-saving data of the terminal device, the terminal device transmits the data processing result to the network data analytics function device as the energy-saving feature data of the terminal device. The network data analytics function device inputs the data processing result and the energy-saving feature data of the radio access network device to the energy-saving configuration generation model in order to generate the energy-saving configuration information through the energy-saving configuration generation model. For descriptions of the energy-saving configuration generation model, refer to the descriptions in the foregoing embodiments. Details are not described herein again.

In some embodiments, the data processing model of the terminal device may be stored on the terminal device, or may be stored on an application service device corresponding to the terminal device. If the data processing model is stored on the terminal device, the terminal device inputs the energy-saving data of the terminal device to the data processing model corresponding to the terminal device, and transmits an output processing result to the network data analytics function device. If the data processing model is stored on the application service device, the terminal device transmits the energy-saving data of the terminal device to the application service device, and the application service device inputs the energy-saving data of the terminal device to the data processing model corresponding to the terminal device, and transmits an output processing result to the network data analytics function device.

For implementation details of S720 and S730 shown in FIG. 9, refer to S720 and S730 shown in FIG. 7. Details are not described herein again.

In the embodiment shown in FIG. 9, the terminal device transmits, to the network data analytics function device, the data processing result obtained by the data processing model of the terminal device by performing data processing on the energy-saving data of the terminal device in order to generate the energy-saving configuration information. This can reduce an amount of transmitted data and improve data security of the terminal device.

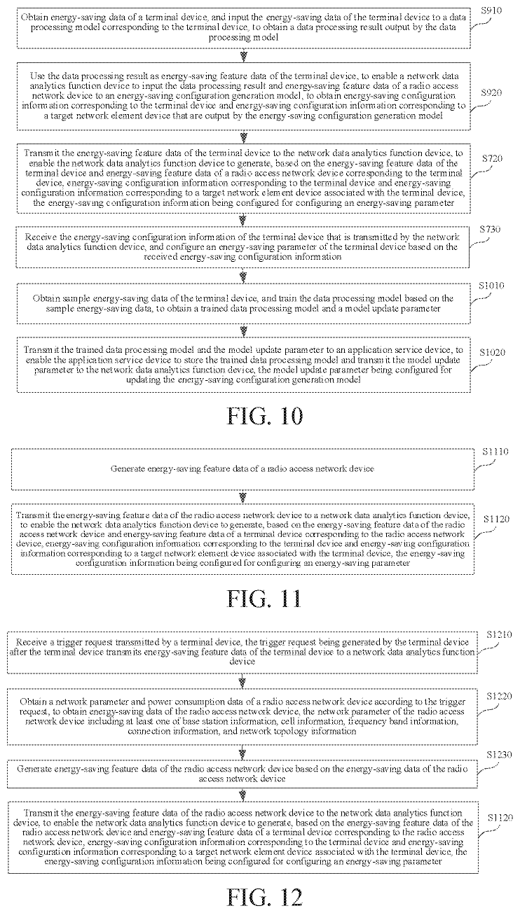

In an exemplary embodiment, FIG. 10 is a flowchart of a parameter configuration method according to another exemplary embodiment of the present disclosure. The method may be applied to the implementation environment shown in FIG. 1, and may be performed by the terminal device 110 in the implementation environment shown in FIG. 1.

As shown in FIG. 10, the parameter configuration method includes S910, S920, S720, S730, S1010, and S1020. Detailed descriptions of S1010 and S1020 are as follows:

S1010: The terminal device obtains sample energy-saving data of the terminal device, and trains the data processing model based on the sample energy-saving data in order to obtain a trained data processing model and a model update parameter.

The sample energy-saving data of the terminal device is energy-saving data of the terminal device that is used as a training sample. The data processing model of the terminal device may be trained based on the sample energy-saving data of the terminal device in order to obtain the trained data processing model and the model update parameter for updating the energy-saving configuration generation model.

S1020: The terminal device transmits the trained data processing model and the model update parameter to an application service device in order to enable the application service device to store the trained data processing model and transmit the model update parameter to the network data analytics function device, the model update parameter being configured to update the energy-saving configuration generation model.

The terminal device transmits the trained data processing model of the terminal device and the model update parameter to the application service device corresponding to the terminal device. The application service device stores the received data processing model, and the application service device transmits the model update parameter to the network data analytics function device. The network data analytics function device updates the energy-saving configuration generation model based on the model update parameter.

In some embodiments, after updating the energy-saving configuration generation model based on the model update parameter, the network data analytics function device may further generate a model update instruction and transmit the model update instruction to the application service device in order to enable the application service device to update the stored data processing model according to the model update instruction.

In this embodiment, the terminal device trains the data processing model, and the application service device stores the data processing model and transmits the model update parameter to the network data analytics function device. In another embodiment, the terminal device may transmit the energy-saving data of the terminal device to the application service device, and the application service device trains and stores the data processing model, and transmits the model update parameter to the network data analytics function device; or the terminal device may train and store the data processing model, and transmit the model update parameter to the network data analytics function device.

For implementation details of S720 and S730 shown in FIG. 10, refer to S720 and S730 shown in FIG. 7. For implementation details of S910 and S920 shown in FIG. 10, refer to S910 and S920 shown in FIG. 9. Details are not described herein again.

In the embodiment shown in FIG. 10, training of the data processing model is associated with a data update of the energy-saving configuration generation model in order to improve accuracy of the data processing model and the energy-saving configuration generation model.

FIG. 11 is a flowchart of a parameter configuration method according to an exemplary embodiment of the present disclosure. The method may be applied to the implementation environment shown in FIG. 1, and may be performed by the radio access network device 120 in the implementation environment shown in FIG. 1.

As shown in FIG. 11, in an exemplary embodiment, the parameter configuration method includes S1110 and S1120. Detailed descriptions of S1110 and S1120 are as follows:

S1110: The radio access network device generates energy-saving feature data of the radio access network device.

The radio access network device may generate the energy-saving feature data of the radio access network device. In some embodiments, the radio access network device may obtain energy-saving data of the radio access network device in order to generate the energy-saving feature data based on the energy-saving data.

A manner of generating the energy-saving feature data by the radio access network device is similar to a manner of generating energy-saving feature data by a terminal device.

In an example, the radio access network device may directly use the energy-saving data of the radio access network device as the energy-saving feature data; or the radio access network device preprocesses the energy-saving data of the radio access network device, and uses preprocessed energy-saving data as the energy-saving feature data of the radio access network device.

In another example, the radio access network device may encrypt the energy-saving data of the radio access network device to obtain energy-saving data of the radio access network device that is in a ciphertext state, and use the energy-saving data of the radio access network device that is in the ciphertext state as the energy-saving feature data of the radio access network device in order to enable a network data analytics function device to generate, based on the energy-saving feature data of the terminal device and the energy-saving data of the radio access network device that is in the ciphertext state, energy-saving configuration information corresponding to the terminal device and energy-saving configuration information corresponding to a target network element device. An encryption algorithm includes, but is not limited to, a homomorphic encryption algorithm.

In another example, a data processing model corresponding to the radio access network device may alternatively be deployed on the radio access network device, the energy-saving data of the radio access network device is input to the data processing model of the radio access network device to obtain a data processing result output by the data processing model, and the data processing result is used as the energy-saving feature data of the radio access network device. In some embodiments, the data processing model of the radio access network device is a machine learning model, and may be a model for extracting feature data from the energy-saving data of the radio access network device, or may be a model for generating energy-saving configuration information of the radio access network device based on the energy-saving data of the radio access network device.

S1120: The radio access network device transmits the energy-saving feature data of the radio access network device to the network data analytics function device in order to enable the network data analytics function device to generate, based on the energy-saving feature data of the radio access network device and energy-saving feature data of a terminal device corresponding to the radio access network device, energy-saving configuration information corresponding to the terminal device and energy-saving configuration information corresponding to a target network element device associated with the terminal device, the energy-saving configuration information being configured to configure an energy-saving parameter.

The terminal device corresponding to the radio access network device is a terminal device served by the radio access network device.

In this embodiment of the present disclosure, after obtaining the energy-saving feature data of the radio access network device, the radio access network device may transmit the energy-saving feature data of the radio access network device to the network data analytics function device, to enable the network data analytics function device to generate, based on the energy-saving feature data of the terminal device and the energy-saving feature data of the radio access network device corresponding to the terminal device, the energy-saving configuration information corresponding to the terminal device and the energy-saving configuration information corresponding to the target network element device. For descriptions of a generation manner, the target network element device, and the energy-saving configuration information, refer to the descriptions in the foregoing embodiments. Details are not described herein again.

In an example, after the radio access network device transmits the energy-saving feature data of the radio access network device to the network data analytics function device, the radio access network device may further receive energy-saving configuration information of the radio access network device that is generated by the network data analytics function device in order to configure an energy-saving parameter of the radio access network device based on the energy-saving configuration information. The energy-saving parameter may include a power consumption parameter of the radio access network device, or may include a parameter related to power consumption of the terminal device, for example, an amount of data transmitted between the radio access network device and the terminal device or bandwidth in order to reduce power consumption of the terminal device while reducing power consumption of the radio access network device.

In the embodiment shown in FIG. 11, in a process of generating the energy-saving configuration information of the terminal device, the network data analytics function device considers both the energy-saving feature data of the terminal device and the energy-saving feature data of the radio access network device corresponding to the terminal device in order to improve accuracy of the energy-saving configuration information of the terminal device, and reduce power consumption of the terminal device. In addition, because a network element device associated with the terminal device also affects power consumption of the terminal device, the network data analytics function device generates both the energy-saving configuration information of the terminal device and energy-saving configuration information of the network element device associated with the terminal device, so that energy-saving control on the terminal device is associated with energy-saving control on the network element device associated with the terminal device. This can not only further reduce power consumption of the terminal device, but also reduce power consumption of an entire network. Moreover, the energy-saving configuration information is generated by the network data analytics function device with a powerful data analytics function, so that accuracy and generation efficiency of the energy-saving configuration information can be improved. Furthermore, the network data analytics function device needs to obtain only the energy-saving feature data corresponding to the terminal device and the energy-saving feature data corresponding to the radio access network device, so that an amount of transmitted data can be reduced.

FIG. 12 is a flowchart of a parameter configuration method according to an exemplary embodiment of the present disclosure. The method may be applied to the implementation environment shown in FIG. 1, and may be performed by the radio access network device 120 in the implementation environment shown in FIG. 1.

As shown in FIG. 12, in an exemplary embodiment, the parameter configuration method may include S1210 to S1230, and S1120. Detailed descriptions of S1210 to S1230 are as follows:

S1210: The radio access network device receives a trigger request transmitted by a terminal device, the trigger request being generated by the terminal device after the terminal device transmits energy-saving feature data of the terminal device to a network data analytics function device.

The radio access network device may receive the trigger request transmitted by the terminal device. The trigger request is configured to trigger the radio access network device to obtain energy-saving data of the radio access network device and report the energy-saving data to the network data analytics function device.

The trigger request may be generated by the terminal device after the terminal device transmits the energy-saving feature data of the terminal device to the network data analytics function device. Alternatively, in another embodiment, the trigger request may be generated by the terminal device when the terminal device determines that energy-saving configuration needs to be performed, or may be generated by the terminal device after the terminal device obtains energy-saving data of the terminal device.

In some embodiments, after receiving the trigger request, the radio access network device may further transmit an acknowledgement message to the terminal device, so that the terminal device determines that the radio access network device has received the trigger request.

S1220: The radio access network device obtains a network parameter and power consumption data of the radio access network device according to the trigger request in order to obtain the energy-saving data of the radio access network device, the network parameter of the radio access network device including at least one of base station information, cell information, frequency band information, connection information, and network topology information.

The radio access network device obtains the network parameter and the power consumption data of the radio access network device according to the trigger request from the terminal device, uses the network parameter and the power consumption data as the energy-saving data of the radio access network device, generates energy-saving feature data based on the energy-saving data, and then transmits the energy-saving feature data to the network data analytics function device.

For descriptions of the network parameter of the radio access network device, refer to the descriptions in the foregoing embodiments. Details are not described herein again. In some embodiments, the radio access network device may collect the network parameter of the radio access network device by using a data collection method like minimization of drive test (MDT), L1 layer (physical layer) measurement, or L3 layer (RRC layer) measurement. The MDT is an automated drive test technology, including an immediate mode and a log mode. RRC stands for radio resource control.

S1230: The radio access network device generates the energy-saving feature data of the radio access network device based on the energy-saving data of the radio access network device.

After obtaining the energy-saving data of the radio access network device, the radio access network device generates the energy-saving feature data of the radio access network device based on the data. For a specific generation manner, refer to the descriptions in the foregoing embodiments. Details are not described herein again.

For specific implementation details of S1120 shown in FIG. 12, refer to S1120 shown in FIG. 11. Details are not described herein again.

In the embodiment shown in FIG. 12, the radio access network device is triggered by the terminal device to obtain the energy-saving data and generate the energy-saving feature data. This can save network resources.

In an exemplary embodiment, FIG. 13 is a flowchart of a parameter configuration method according to another exemplary embodiment of the present disclosure. The method may be applied to the implementation environment shown in FIG. 1, and may be performed by the radio access network device 120 in the implementation environment shown in FIG. 1.

As shown in FIG. 13, the parameter configuration method includes S1210 to S1230, S1310, S1320, and S1120. Detailed descriptions of S1310 and S1320 are as follows:

S1310: The radio access network device obtains a data transmission record of the terminal device according to the trigger request, and obtains network configuration information of the terminal device based on the data transmission record of the terminal device.

In a process in which the terminal device performs data transmission with another device through a radio access network, a radio access network device corresponding to the terminal device obtains data transmitted by the terminal device or data transmitted by the another device to the terminal device. To improve accuracy of energy-saving configuration information, after receiving the trigger request from the terminal device, the radio access network device may obtain the data transmission record of the terminal device, to obtain the network configuration information of the terminal device, for example, bandwidth or a frequency band of the terminal device, based on the data transmission record of the terminal device.

S1320: The radio access network device adds the network configuration information of the terminal device to the energy-saving data of the radio access network device.

After obtaining the network configuration information of the terminal device, the radio access network device may further add the network configuration information of the terminal device to the energy-saving data of the radio access network device in order to transmit the network configuration information of the terminal device to the network data analytics function device together with the energy-saving data of the radio access network device.

In some embodiments, the radio access network device may further obtain a data transmission scenario of the terminal device based on the data transmission record of the terminal device. For example, the radio access network device adds the data transmission scenario to the energy-saving data of the radio access network device based on a corresponding service type (for example, an instant messaging service, a non-instant-messaging service, or the like) and a type of transmitted data (for example, a video, audio, or the like), to transmit the data transmission scenario to the network data analytics function device together with the energy-saving data of the radio access network device.

For implementation details of S1120 shown in FIG. 13, refer to S1120 shown in FIG. 11. For implementation details of S1210 to S1230 shown in FIG. 13, refer to S1210 to S1230 shown in FIG. 12. Details are not described herein again.

In the embodiment shown in FIG. 13, the radio access network device further obtains the network configuration information of the terminal device based on the data transmission record of the terminal device, and adds the network configuration information to the energy-saving data for generating energy-saving configuration information. This can improve accuracy of the energy-saving configuration information.

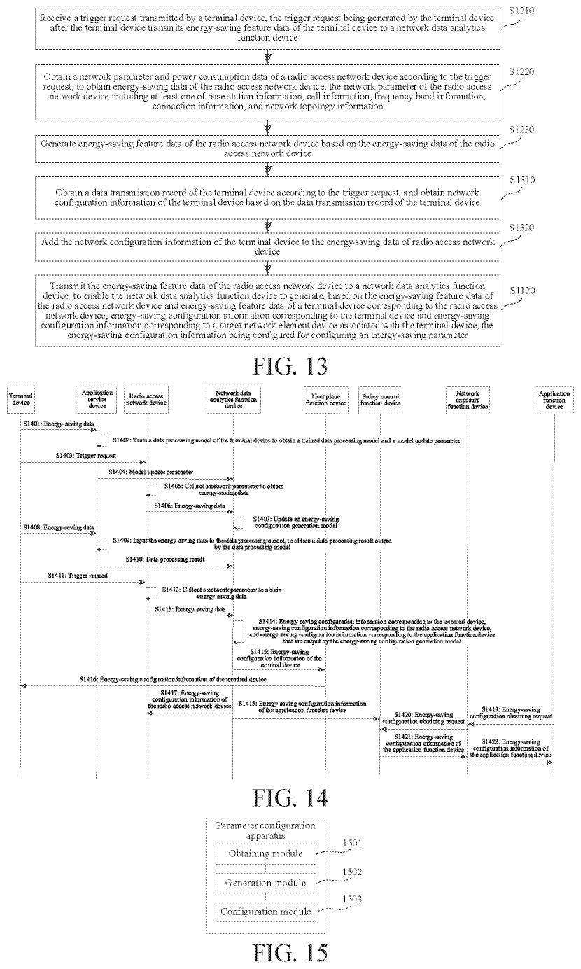

In an exemplary embodiment, FIG. 14 is a flowchart of a parameter configuration method according to another exemplary embodiment of the present disclosure. The method may be jointly performed by a terminal device, an application service device, a radio access network device, a network data analytics function device, a user plane function device, a policy control function device, a network exposure function device, and an application function device. As shown in FIG. 14, the parameter configuration method includes operations S1401 to S1422. Detailed descriptions are as follows:

S1401: The terminal device obtains energy-saving data of the terminal device and transmits the energy-saving data to the application service device.

When model training needs to be performed, the terminal device may collect network-layer data, application-layer data, power consumption data, and the like through a network interface of the terminal device, to obtain the energy-saving data of the terminal device, for example, including but not limited to, at least one of reference signal received power, reference signal received quality, a received signal strength indicator, a throughput, and a data rate.

After collecting the energy-saving data, the terminal device may transmit the energy-saving data to the application service device. In some embodiments, the terminal device may preprocess the energy-saving data and then transmit the energy-saving data to the application service device.

S1402: The application service device trains a data processing model of the terminal device based on the energy-saving data of the terminal device in order to obtain a trained data processing model and a model update parameter.

The application service device trains the data processing model of the terminal device based on the received energy-saving data in order to obtain the trained data processing model and the model update parameter, and stores the trained data processing model.

S1403: The terminal device transmits a trigger request to the radio access network device.

To enable the radio access network device to collect energy-saving data for model training, the terminal device may transmit the trigger request to the radio access network device.

In this embodiment, a sequence of performing S1401 and S1403 is not limited. Alternatively, S1401 may be performed before S1403, or S1401 and S1403 may be simultaneously performed.

S1404: The application service device transmits the model update parameter to the network data analytics function device.

To enable the network data analytics function device to update an energy-saving configuration generation model based on the model update parameter, the application service device may transmit the model update parameter to the network data analytics function device.

S1405: The radio access network device collects a network parameter according to the trigger request, to obtain energy-saving data.

After receiving the trigger request, the radio access network device may collect a network parameter at a radio access network level, for example, at least one of base station information, cell information, frequency band information, user connection information, and network topology information, by using a data collection method like MDT, L1 measurement, or L3 measurement in order to obtain the energy-saving data of the radio access network device.

S1406: The radio access network device transmits the energy-saving data to the network data analytics function device.

In some embodiments, the radio access network device may further obtain network configuration information, service information, or the like of the terminal device based on data transmission behavior of the terminal device, and add the obtained information to the energy-saving data.

In this embodiment, the radio access network device directly transmits the energy-saving data of the radio access network device to the network data analytics function device for model training. In another embodiment, the radio access network device may alternatively include a data processing model, and the radio access network device may train the data processing model based on the energy-saving data of the radio access network device, and transmit a model update parameter obtained through training to the network data analytics function device for model training.

S1407: The network data analytics function device updates the energy-saving configuration generation model based on the model update parameter and the energy-saving data of the radio access network device.

In some embodiments, after updating the energy-saving configuration generation model, the network data analytics function device may further generate a model update instruction based on an updated energy-saving configuration generation model, and transmit the model update instruction to the application service device in order to enable the application service device to update the data processing model according to the model update instruction. The data processing model and the energy-saving configuration generation model form a vertical federated learning model.

S1408: The terminal device obtains energy-saving data of the terminal device and transmits the energy-saving data to the application service device.

When energy-saving configuration information needs to be generated, the terminal device may obtain the energy-saving data of the terminal device and transmit the energy-saving data to the application service device.

S1409: The application service device inputs the energy-saving data to the data processing model in order to obtain a data processing result output by the data processing model.

After receiving the energy-saving data of the terminal device, the application service device invokes the data processing model to process the energy-saving data in order to obtain the data processing result.

S1410: The application service device transmits the data processing result to the network data analytics function device.

S1411: The terminal device transmits a trigger request to the radio access network device.

To enable the radio access network device to collect energy-saving data for generating energy-saving configuration information, the terminal device may transmit the trigger request to the radio access network device.

S1412: The radio access network device collects a network parameter according to the trigger request in order to obtain energy-saving data.

For a data collection process, refer to S1405. Details are not described herein again.

S1413: The radio access network device transmits the energy-saving data to the network data analytics function device.

In this embodiment, the radio access network device directly transmits the energy-saving data of the radio access network device to the network data analytics function device in order to generate energy-saving configuration information. In another embodiment, the radio access network device may alternatively input the energy-saving data to the data processing model of the radio access network device, and transmit a data processing result output by the model to the network data analytics function device in order to generate energy-saving configuration information.

S1414: The network data analytics function device inputs the data processing result and the energy-saving data of the radio access network device to the energy-saving configuration generation model in order to obtain energy-saving configuration information corresponding to the terminal device, energy-saving configuration information corresponding to the radio access network device, and energy-saving configuration information corresponding to the application function device that are output by the energy-saving configuration generation model.

The network data analytics function device may invoke the energy-saving configuration generation model to perform deduction analysis on the data processing result and the energy-saving data of the radio access network device in order to generate the energy-saving configuration information corresponding to the terminal device, the energy-saving configuration information corresponding to the radio access network device, and the energy-saving configuration information corresponding to the application function device.

S1415: The network data analytics function device transmits the energy-saving configuration information of the terminal device to the user plane function device.

To transmit the energy-saving configuration information of the terminal device to the terminal device, the network data analytics function device may transmit the energy-saving configuration information of the terminal device to the user plane function device.

S1416: The user plane function device transmits the energy-saving configuration information of the terminal device to the terminal device.

After receiving the energy-saving configuration information of the terminal device, the user plane function device may expose the energy-saving configuration information of the terminal device to the terminal device. In some embodiments, the energy-saving configuration information of the terminal device may be transmitted to the terminal device through an N6 interface. After receiving the energy-saving configuration information, the terminal device may feed an acknowledgement message back to the user plane function device.

S1417: The network data analytics function device transmits the energy-saving configuration information of the radio access network device to the radio access network device.

In some embodiments, after receiving the energy-saving configuration information, the radio access network device may transmit an acknowledgement message to the network data analytics function device, so that the network data analytics function device determines that the radio access network device has received the energy-saving configuration information.

S1418: The network data analytics function device transmits the energy-saving configuration information of the application function device to the policy control function device.

To transmit the energy-saving configuration information of the application function device to the application function device, the energy-saving configuration information of the application function device may be first transmitted to the policy control function device.

S1419: The application function device transmits an energy-saving configuration obtaining request to the network exposure function device.

To obtain the energy-saving configuration information, the application function device may transmit the energy-saving configuration obtaining request to the network exposure function device.

S1420: The network exposure function device transmits the energy-saving configuration obtaining request to the policy control function device.

To enable the policy control function device to transmit the energy-saving configuration information, the network exposure function device may transmit the received energy-saving configuration obtaining request to the policy control function device.

S1421: The policy control function device transmits the energy-saving configuration information of the application function device to the network exposure function device.

The policy control function device transmits the energy-saving configuration information of the application function device to the network exposure function device according to the received energy-saving configuration obtaining request.

S1422: The network exposure function device transmits the energy-saving configuration information of the application function device to the application function device.

In some embodiments, after receiving the energy-saving configuration information, the application function device may transmit an acknowledgement message to the network exposure function device, so that the network exposure function device determines that the application function device has received the energy-saving configuration information.

After receiving their respective energy-saving configuration information, the terminal device, the radio access network device, and the application function device may configure their energy-saving parameters based on the energy-saving configuration information.

In some embodiments, before S1401, the terminal device may initiate a protocol data unit (PDU) session request for model maintenance, that is, a model maintenance request, to enable an authentication management function (AMF) device or the like to create a session according to the request. Subsequently, the terminal device may transmit data to the application service device and the radio access network device, receive data transmitted by the network data analytics function device, or the like through the session. Before S1408, the terminal device may initiate a PDU session request for energy-saving configuration, that is, an energy-saving configuration request, to enable the authentication management function device or the like to create a session according to the request. Subsequently, the terminal device may transmit data to the application service device and the radio access network device, receive energy-saving configuration information transmitted by the network data analytics function device, or the like through the session.

For implementations of operations S1410 to S1422 shown in FIG. 14, refer to the detailed descriptions in the foregoing embodiments. Details are not described herein again.

In the embodiment shown in FIG. 14, in a process of generating the energy-saving configuration information of the terminal device, the network data analytics function device considers both the energy-saving feature data of the terminal device and the energy-saving feature data of the radio access network device corresponding to the terminal device, to improve accuracy of the energy-saving configuration information of the terminal device, and reduce power consumption of the terminal device. Further, energy-saving configuration information of a network element device associated with the terminal device is generated, so that energy-saving control on the terminal device is associated with energy-saving control on the network element device associated with the terminal device. This can not only further reduce power consumption of the terminal device, but also reduce power consumption of an entire network. Moreover, the energy-saving configuration information is generated by the network data analytics function device with a powerful data analytics function, so that accuracy and generation efficiency of the energy-saving configuration information can be improved. Furthermore, the network data analytics function device needs to obtain only the data processing result obtained by the data processing model by performing data processing on the energy-saving data of the terminal device. This can not only improve data security of the terminal device, but also reduce an amount of transmitted data.

FIG. 15 is a block diagram of a parameter configuration apparatus according to an exemplary embodiment of the present disclosure. The apparatus is applied to a network data analytics function device. As shown in FIG. 15, the apparatus includes: an obtaining module 1501, configured to obtain energy-saving feature data of a terminal device and energy-saving feature data of a radio access network device corresponding to the terminal device; a generation module 1502, configured to generate, based on the energy-saving feature data of the terminal device and the energy-saving feature data of the radio access network device, energy-saving configuration information corresponding to the terminal device and energy-saving configuration information corresponding to a target network element device associated with the terminal device, the energy-saving configuration information being configured to configure an energy-saving parameter; and a configuration module 1503, configured to transmit the energy-saving configuration information of the terminal device to the terminal device, and transmit the energy-saving configuration information of the target network element device to the target network element device in order to enable the terminal device to configure an energy-saving parameter of the terminal device based on the energy-saving configuration information of the terminal device, and enable the target network element device to configure an energy-saving parameter of the target network element device based on the energy-saving configuration information of the target network element device.

In an exemplary embodiment, based on the foregoing solution, the obtaining module 1501 is configured to input the energy-saving feature data of the terminal device and the energy-saving feature data of the radio access network device to an energy-saving configuration generation model in order to obtain the energy-saving configuration information corresponding to the terminal device and the energy-saving configuration information corresponding to the target network element device that are output by the energy-saving configuration generation model.

In an exemplary embodiment, based on the foregoing solution, under the condition that the energy-saving feature data of the terminal device includes a data processing result output by a data processing model corresponding to the terminal device after the data processing model processes the energy-saving data of the terminal device, the apparatus further includes an update module, configured to: obtain model update parameters respectively corresponding to a plurality of terminal devices, a model update parameter of each terminal device being obtained by training, based on sample energy-saving data of the terminal device, a data processing model corresponding to the terminal device; and update the energy-saving configuration generation model based on sample energy-saving feature data of radio access network devices respectively corresponding to the plurality of terminal devices and the model update parameters of the plurality of terminal devices.

In an exemplary embodiment, based on the foregoing solution, under the condition that the target network element device includes an application function device corresponding to the terminal device, the configuration module 1503 is configured to transmit energy-saving configuration information of the application function device to a policy control function device, to enable the policy control function device to transmit the energy-saving configuration information of the application function device to the application function device through a network exposure function device after receiving an energy-saving configuration obtaining request from the application function device through the network exposure function device.

In an exemplary embodiment, based on the foregoing solution, under the condition that the target network element device includes the radio access network device, the configuration module 1503 is configured to: transmit the energy-saving configuration information of the terminal device to a user plane function device in order to enable the user plane function device to transmit the energy-saving configuration information of the terminal device to the terminal device; and transmit energy-saving configuration information of the radio access network device to the radio access network device.

The parameter configuration apparatus provided in FIG. 15 belongs to the same concept as the parameter configuration method that is provided in the foregoing embodiments and that corresponds to the network data analytics function device. Specific manners of performing operations by the modules and units are described in detail in the method embodiments. Details are not described herein again.

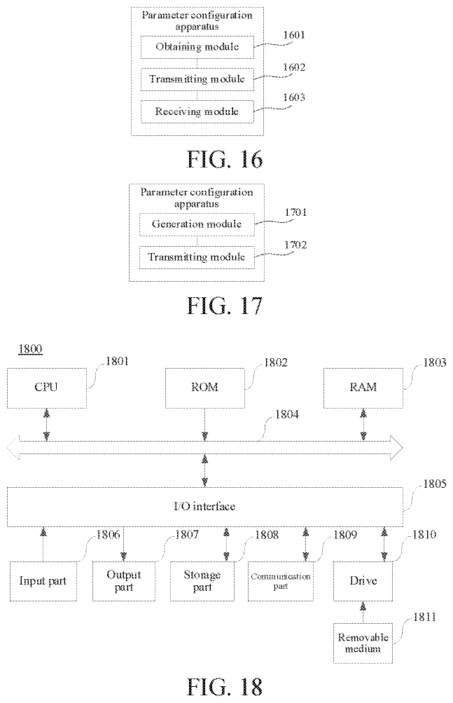

FIG. 16 is a block diagram of a parameter configuration apparatus according to an exemplary embodiment of the present disclosure. As shown in FIG. 16, the apparatus includes:
an obtaining module 1601, configured to generate energy-saving feature data of a radio access network device;
a transmitting module 1602, configured to transmit energy-saving feature data of a terminal device to a network data analytics function device in order to enable the network data analytics function device to generate, based on the energy-saving feature data of the terminal device and energy-saving feature data of a radio access network device corresponding to the terminal device, energy-saving configuration information corresponding to the terminal device and energy-saving configuration information corresponding to a target network element device associated with the terminal device, the energy-saving configuration information being configured to configure an energy-saving parameter; and
a receiving module 1603, configured to receive the energy-saving configuration information of the terminal device that is transmitted by the network data analytics function device, and configure an energy-saving parameter of the terminal device based on the received energy-saving configuration information.

In an exemplary embodiment, based on the foregoing solution, the obtaining module 1601 is configured to: encrypt energy-saving data of the terminal device to obtain energy-saving data of the terminal device that is in a ciphertext state, the energy-saving data of the terminal device including at least one of network-layer data, power consumption data, and application-layer data of the terminal device, and the network-layer parameter of the terminal device including at least one of reference signal received power, reference signal received quality, a received signal strength indicator, a throughput, and a data rate; and use the energy-saving data of the terminal device that is in the ciphertext state as the energy-saving feature data of the terminal device, to enable the network data analytics function device to generate, based on the energy-saving feature data of the radio access network device and the energy-saving data of the terminal device that is in the ciphertext state, the energy-saving configuration information corresponding to the terminal device and the energy-saving configuration information corresponding to the target network element device.

In an exemplary embodiment, based on the foregoing solution, the obtaining module 1601 is configured to: input the energy-saving data of the terminal device to a data processing model corresponding to the terminal device, to obtain a data processing result output by the data processing model; and use the data processing result as the energy-saving feature data of the terminal device, to enable the network data analytics function device to input the data processing result and the energy-saving feature data of the radio access network device to an energy-saving configuration generation model, to obtain the energy-saving configuration information corresponding to the terminal device and the energy-saving configuration information corresponding to the target network element device that are output by the energy-saving configuration generation model.

In an exemplary embodiment, based on the foregoing solution, the apparatus further includes a training module, configured to: obtain sample energy-saving data of the terminal device, and train the data processing model based on the sample energy-saving data, to obtain a trained data processing model and a model update parameter; and transmit the trained data processing model and the model update parameter to an application service device, to enable the application service device to store the trained data processing model and transmit the model update parameter to the network data analytics function device, the model update parameter being configured for updating the energy-saving configuration generation model.

The parameter configuration apparatus provided in FIG. 16 belongs to the same concept as the parameter configuration method that is provided in the foregoing embodiments and that corresponds to the terminal device. Specific manners of performing operations by the modules and units are described in detail in the method embodiments. Details are not described herein again.

FIG. 17 is a block diagram of a parameter configuration apparatus according to an exemplary embodiment of the present disclosure. As shown in FIG. 17, the apparatus includes:
a generation module 1701 configured to generate energy-saving feature data of a radio access network device; and
a transmitting module 1702 configured to transmit the energy-saving feature data of the radio access network device to a network data analytics function device in order to enable the network data analytics function device to generate, based on the energy-saving feature data of the radio access network device and energy-saving feature data of a terminal device corresponding to the radio access network device, energy-saving configuration information corresponding to the terminal device and energy-saving configuration information corresponding to a target network element device associated with the terminal device, the energy-saving configuration information being configured for configuring an energy-saving parameter.

In an exemplary embodiment, based on the foregoing solution, the generation module 1701 is configured to: receive a trigger request transmitted by the terminal device, the trigger request being generated by the terminal device after the terminal device transmits the energy-saving feature data of the terminal device to the network data analytics function device; obtain a network parameter and power consumption data of the radio access network device according to the trigger request, to obtain energy-saving data of the radio access network device, the network parameter of the radio access network device including at least one of base station information, cell information, frequency band information, connection information, and network topology information; and generate the energy-saving feature data of the radio access network device based on the energy-saving data of the radio access network device.

In an exemplary embodiment, based on the foregoing solution, the apparatus further includes a collection module, configured to: obtain a data transmission record of the terminal device according to the trigger request, and obtain network configuration information of the terminal device based on the data transmission record of the terminal device; and add the network configuration information of the terminal device to the energy-saving data of the radio access network device.

The parameter configuration apparatus provided in FIG. 17 belongs to the same concept as the parameter configuration method that is provided in the foregoing embodiments and that corresponds to the radio access network device. Specific manners of performing operations by the modules and units are described in detail in the method embodiments. Details are not described herein again.

Embodiments of the present disclosure further provide an electronic device, including: one or more processors; and a storage apparatus, configured to store one or more computer programs, the one or more computer programs, when executed by the one or more processors, causing the electronic device to implement the parameter configuration method provided in the foregoing embodiments.

FIG. 18 is a schematic structural diagram of a computer system adapted to implement an electronic device according to an embodiment of the present disclosure.

The computer system 1800 of the electronic device shown in FIG. 18 is merely an example, and does not constitute any limitation on functions and use ranges of embodiments of the present disclosure.

As shown in FIG. 18, the computer system 1800 includes a central processing unit (CPU) 1801, which may perform various appropriate actions and processing based on a computer program stored in a read-only memory (ROM) 1802 or a computer program loaded from a storage part 1808 to a random access memory (RAM) 1803, for example, perform the parameter configuration method in the foregoing embodiments. The RAM 1803 further stores various computer programs and data needed for system operations. The CPU 1801, the ROM 1802, and the RAM 1803 are connected to each other through a bus 1804. An input/output (I/O) interface 1805 is also connected to the bus 1804.

In some embodiments, the following components are connected to the I/O interface 1805: an input part 1806 including a keyboard, a mouse, or the like, an output part 1807 including a cathode ray tube (CRT), a liquid crystal display (LCD), a speaker, or the like, the storage part 1808 including a hard disk or the like, and a communication part 1809 including a network interface card such as a local area network (LAN) card or a modem. The communication part 1809 performs communication processing through a network such as the Internet. A drive 1810 is also connected to the I/O interface 1805 as needed. A removable medium 1811, such as a magnetic disk, an optical disc, a magneto-optical disk, or a semiconductor memory, is installed on the drive 1810 as needed, so that a computer program read from the removable medium is installed into the storage part 1808 as needed.

Particularly, according to the embodiments of the present disclosure, a computer program for implementing the parameter configuration method may be carried in a computer-readable medium, and the computer program may be downloaded and installed from a network through the communication part 1809, and/or installed from the removable medium 1811.

The computer-readable medium shown in the embodiments of the present disclosure may be a computer-readable signal medium, a computer-readable storage medium, or any combination thereof. For example, the computer-readable storage medium may be an electrical, magnetic, optical, electromagnetic, infrared, or semiconductor system, apparatus, or component, or any combination thereof. A more specific example of the computer-readable storage medium may include but is not limited to: an electrical connection with one or more wires, a portable computer magnetic disk, a hard disk, a RAM, a ROM, an erasable programmable read-only memory (EPROM), a flash memory, an optical fiber, a compact disc read-only memory (CD-ROM), an optical storage device, a magnetic storage device, or any appropriate combination thereof. In the present disclosure, the computer-readable storage medium may be any tangible medium including or storing a computer program, and the computer program may be used by or used in combination with an instruction execution system, apparatus, or component. The computer-readable signal medium may include a data signal transmitted in a baseband or as a part of a carrier, and carries a computer-readable computer program. The data signal transmitted in this manner may be in a plurality of forms, including but not limited to an electromagnetic signal, an optical signal, or any appropriate combination thereof. The computer program included in the computer-readable medium may be transmitted through any suitable medium, including but not limited to a wireless medium, a wired medium, or the like, or any appropriate combination thereof.

The flowcharts and block diagrams in the accompanying drawings illustrate possible system architectures, functions, and operations that may be implemented by a system, a method, and a computer program product according to various embodiments of the present disclosure. Each block in a flowchart or a block diagram may represent a module, a program segment, or a part of code. The module, the program segment, or the part of code includes one or more executable instructions for implementing a specified logic function. In some alternative implementations, functions annotated in blocks may alternatively occur in a sequence different from that annotated in the accompanying drawings. For example, two blocks shown in succession may actually be performed basically in parallel, or may sometimes be performed in a reverse sequence. This is determined based on a related function. Each block in a block diagram or a flowchart and a combination of blocks in the block diagram or the flowchart may be implemented by a dedicated hardware-based system configured to perform a specified function or operation, or may be implemented by a combination of dedicated hardware and a computer program.

A related unit described in the embodiments of the present disclosure may be implemented in a software manner, or may be implemented in a hardware manner, and the described unit may alternatively disposed in a processor. Names of the units do not constitute a limitation on the units in a specific case.

Another aspect of the present disclosure further provides a computer-readable storage medium, having a computer program stored therein, the computer program, when executed by a processor of an electronic device, implementing the foregoing parameter configuration method. The computer-readable storage medium may be included in the electronic device described in the foregoing embodiments, or may exist alone and is not assembled in the electronic device.

Another aspect of the present disclosure further provides a computer program product, the computer program product including a computer program, and the computer program, when executed by a processor, implementing the parameter configuration method provided in the foregoing embodiments. The computer program may be stored in a computer-readable storage medium.

The foregoing content is merely exemplary embodiments of the present disclosure, and is not intended to limit implementation solutions of the present disclosure. A person of ordinary skill in the art may conveniently make variations or modifications based on the main concept and spirit of the present disclosure. Therefore, the protection scope of the present disclosure shall be subject to the protection scope of the claims.

What is claimed is

1. A parameter configuration method applied to a network data analytics function device, the method comprising:
obtaining energy-saving feature data of a terminal device and energy-saving feature data of a radio access network device corresponding to the terminal device;
generating, based on the energy-saving feature data of the terminal device and the energy-saving feature data of the radio access network device, energy-saving configuration information corresponding to the terminal device and energy-saving configuration information corresponding to a target network element device associated with the terminal device, the energy-saving configuration information being configured to configure an energy-saving parameter;
transmitting the energy-saving configuration information of the terminal device to the terminal device;
transmitting the energy-saving configuration information of the target network element device to the target network element device;
enabling the terminal device to configure an energy-saving parameter of the terminal device based on the energy-saving configuration information of the terminal device; and
enabling the target network element device to configure an energy-saving parameter of the target network element device based on the energy-saving configuration information of the target network element device.

2. The parameter configuration method according to claim 1, wherein the generating, based on the energy-saving feature data of the terminal device and the energy-saving feature data of the radio access network device, energy-saving configuration information corresponding to the terminal device and energy-saving configuration information corresponding to a target network element device associated with the terminal device comprises:
inputting the energy-saving feature data of the terminal device and the energy-saving feature data of the radio access network device to an energy-saving configuration generation model; and
obtain the energy-saving configuration information corresponding to the terminal device and the energy-saving configuration information corresponding to the target network element device that are output by the energy-saving configuration generation model.

3. The parameter configuration method according to claim 1, wherein the energy-saving feature data of the terminal device comprises a data processing result output by a data processing model corresponding to the terminal device after the data processing model processes energy-saving data of the terminal device; and
the parameter configuration method further comprises:
obtaining model update parameters respectively corresponding to a plurality of terminal devices, a model update parameter of each terminal device being obtained by training, based on sample energy-saving data of the terminal device, a data processing model corresponding to the terminal device; and
updating the energy-saving configuration generation model based on sample energy-saving feature data of radio access network devices respectively corresponding to the plurality of terminal devices and the model update parameters of the plurality of terminal devices.

4. The parameter configuration method according to claim 1, wherein
the target network element device comprises an application function device corresponding to the terminal device, and
the transmitting the energy-saving configuration information of the target network element device to the target network element device comprises:
transmitting energy-saving configuration information of the application function device to a policy control function device; and
enabling the policy control function device to transmit the energy-saving configuration information of the application function device to the application function device through a network exposure function device after receiving an energy-saving configuration obtaining request from the application function device through the network exposure function device.

5. The parameter configuration method according to claim 1, wherein
the target network element device comprises the radio access network device, and the transmitting the energy-saving configuration information of the terminal device to the terminal device, and
transmitting the energy-saving configuration information of the target network element device to the target network element device comprises:
transmitting the energy-saving configuration information of the terminal device to a user plane function device;
enabling the user plane function device to transmit the energy-saving configuration information of the terminal device to the terminal device; and
transmitting energy-saving configuration information of the radio access network device to the radio access network device.

6. The parameter configuration method according to claim 1, wherein the energy-saving feature data of the terminal device is generated at least based on:
energy-saving data of the terminal device being encrypted to be energy-saving data of the terminal device in a ciphertext state, the energy-saving data of the terminal device comprising at least one of (i) network-layer data, (ii) power consumption data, and (iii) application-layer data of the terminal device.

7. The parameter configuration method according to claim 6, wherein the network-layer data of the terminal device comprising at least one of (i) reference signal received power, (ii) reference signal received quality, (iii) a received signal strength indicator, (iv) a throughput, and (v) a data rate.

8. A parameter configuration apparatus applied to a network data analytics function device, the apparatus comprising:
at least one memory configured to store program code; and
at least one processor configured to read the program code and operate as instructed by the program code, the program code comprising:
a first obtaining code configured to cause the at least one of the at least one processor to obtain energy-saving feature data of a terminal device and energy-saving feature data of a radio access network device corresponding to the terminal device;
a generation code configured to cause the at least one of the at least one processor to generate, based on the energy-saving feature data of the terminal device and the energy-saving feature data of the radio access network device, energy-saving configuration information corresponding to the terminal device and energy-saving configuration information corresponding to a target network element device associated with the terminal device, the energy-saving configuration information being configured to configure an energy-saving parameter;
a first transmitting code configured to cause the at least one of the at least one processor to transmit the energy-saving configuration information of the terminal device to the terminal device;
a second transmitting code configured to cause the at least one of the at least one processor to transmit the energy-saving configuration information of the target network element device to the target network element device;
a first enabling code configured to cause the at least one of the at least one processor to enable the terminal device to configure an energy-saving parameter of the terminal device based on the energy-saving configuration information of the terminal device; and
a second enabling code configured to cause the at least one of the at least one processor to enable the target network element device to configure an energy-saving parameter of the target network element device based on the energy-saving configuration information of the target network element device.

9. The parameter configuration apparatus according to claim 8, wherein the generating code is further configured to cause at least one of the at least one processor to:
input the energy-saving feature data of the terminal device and the energy-saving feature data of the radio access network device to an energy-saving configuration generation model; and
obtain the energy-saving configuration information corresponding to the terminal device and the energy-saving configuration information corresponding to the target network element device that are output by the energy-saving configuration generation model.

10. The parameter configuration apparatus according to claim 8, wherein the energy-saving feature data of the terminal device comprises a data processing result output by a data processing model corresponding to the terminal device after the data processing model processes energy-saving data of the terminal device; and the program code further comprising:
a second obtaining code configured to cause the at least one of the at least one processor to obtain model update parameters respectively corresponding to a plurality of terminal devices, a model update parameter of each terminal device being obtained by training, based on sample energy-saving data of the terminal device, a data processing model corresponding to the terminal device; and
an updating code configured to cause the at least one of the at least one processor to update the energy-saving configuration generation model based on sample energy-saving feature data of radio access network devices respectively corresponding to the plurality of terminal devices and the model update parameters of the plurality of terminal devices.

11. The parameter configuration apparatus according to claim 8, wherein the target network element device comprises an application function device corresponding to the terminal device, and the second transmitting code further comprising:
a third transmitting code configured to cause the at least one of the at least one processor to transmit energy-saving configuration information of the application function device to a policy control function device; and
a third enabling code configured to cause the at least one of the at least one processor to enable the policy control function device to transmit the energy-saving configuration information of the application function device to the application function device through a network exposure function device after receiving an energy-saving configuration obtaining request from the application function device through the network exposure function device.

12. The parameter configuration apparatus according to claim 8, wherein the target network element device comprises the radio access network device, the first transmitting code, and the second transmitting code further comprising:
a fourth transmitting code configured to cause the at least one of the at least one processor to transmit the energy-saving configuration information of the terminal device to a user plane function device;
a fourth enabling code configured to cause the at least one of the at least one processor to enable the user plane function device to transmit the energy-saving configuration information of the terminal device to the terminal device; and
a fifth transmitting code configured to cause the at least one of the at least one processor to transmit energy-saving configuration information of the radio access network device to the radio access network device.

13. The parameter configuration apparatus according to claim 8, wherein the energy-saving feature data of the terminal device is generated at least based on:
energy-saving data of the terminal device being encrypted to be energy-saving data of the terminal device in a ciphertext state, the energy-saving data of the terminal device comprising at least one of (i) network-layer data, (ii) power consumption data, and (iii) application-layer data of the terminal device.

14. The parameter configuration apparatus according to claim 13, wherein the network-layer data of the terminal device comprising at least one of (i) reference signal received power, (ii) reference signal received quality, (iii) a received signal strength indicator, (iv) a throughput, and (v) a data rate.

15. A non-transitory computer-readable storage medium, storing computer code which, when executed by at least one processor, causes the at least one processor to at least:
obtain energy-saving feature data of a terminal device and energy-saving feature data of a radio access network device corresponding to the terminal device;
generate, based on the energy-saving feature data of the terminal device and the energy-saving feature data of the radio access network device, energy-saving configuration information corresponding to the terminal device and energy-saving configuration information corresponding to a target network element device associated with the terminal device, the energy-saving configuration information being configured to configure an energy-saving parameter;
transmit the energy-saving configuration information of the terminal device to the terminal device;
transmit the energy-saving configuration information of the target network element device to the target network element device;
enable the terminal device to configure an energy-saving parameter of the terminal device based on the energy-saving configuration information of the terminal device; and
enable the target network element device to configure an energy-saving parameter of the target network element device based on the energy-saving configuration information of the target network element device.

16. The non-transitory computer-readable storage medium according to claim 15, wherein the generating, based on the energy-saving feature data of the terminal device and the energy-saving feature data of the radio access network device, energy-saving configuration information corresponding to the terminal device and energy-saving configuration information corresponding to a target network element device associated with the terminal device comprises:
inputting the energy-saving feature data of the terminal device and the energy-saving feature data of the radio access network device to an energy-saving configuration generation model; and
obtain the energy-saving configuration information corresponding to the terminal device and the energy-saving configuration information corresponding to the target network element device that are output by the energy-saving configuration generation model.

17. The non-transitory computer-readable storage medium according to claim 15, wherein the energy-saving feature data of the terminal device comprises a data processing result output by a data processing model corresponding to the terminal device after the data processing model processes energy-saving data of the terminal device; and
the parameter configuration method further comprises:
obtaining model update parameters respectively corresponding to a plurality of terminal devices, a model update parameter of each terminal device being obtained by training, based on sample energy-saving data of the terminal device, a data processing model corresponding to the terminal device; and
updating the energy-saving configuration generation model based on sample energy-saving feature data of radio access network devices respectively corresponding to the plurality of terminal devices and the model update parameters of the plurality of terminal devices.

18. The non-transitory computer-readable storage medium according to claim 15, wherein
the target network element device comprises an application function device corresponding to the terminal device, and
the transmitting the energy-saving configuration information of the target network element device to the target network element device comprises:
transmitting energy-saving configuration information of the application function device to a policy control function device; and
enabling the policy control function device to transmit the energy-saving configuration information of the application function device to the application function device through a network exposure function device after receiving an energy-saving configuration obtaining request from the application function device through the network exposure function device.

19. The non-transitory computer-readable storage medium according to claim 15, wherein
the target network element device comprises the radio access network device, and the transmitting the energy-saving configuration information of the terminal device to the terminal device, and
transmitting the energy-saving configuration information of the target network element device to the target network element device comprises:
transmitting the energy-saving configuration information of the terminal device to a user plane function device;
enabling the user plane function device to transmit the energy-saving configuration information of the terminal device to the terminal device; and
transmitting energy-saving configuration information of the radio access network device to the radio access network device.

20. The non-transitory computer-readable storage medium according to claim 15, wherein the energy-saving feature data of the terminal device is generated at least based on:
energy-saving data of the terminal device being encrypted to be energy-saving data of the terminal device in a ciphertext state, the energy-saving data of the terminal device comprising at least one of (i) network-layer data, (ii) power consumption data, and (iii) application-layer data of the terminal device.
